(19) United States
(12) Patent Application Publication
(10) Pub. No.: US 2007/0008624 A1
(43) Pub. Date: Jan. 11, 2007

(54) Optical image display system and image display unit

(75) Inventor: Yoshikazu Hirayama, Tokyo (JP)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 11/520,559

(22) Filed: Sep. 12, 2006

Related U.S. Application Data
(63) Continuation of application No. PCT/JP05/01963, filed on Feb. 9, 2005.

(30) Foreign Application Priority Data
Mar. 12, 2004 (JP) 2004-071511
Aug. 6, 2004 (JP) 2004-230528

(51) Int. Cl. G02B 27/14

(52) U.S. Cl. 359/630

(57) ABSTRACT

Optical-image display systems are disclosed having simple structure and a large exit pupil. An exemplary system includes a transmissive plate having inside an optical path of light flux from a display at each angular field of view of an image-display element. The light flux is internally reflected repeatedly in the transmissive plate. An optical-deflection member is provided in close contact with a predetermined region of one surface of the plate used for internal reflection. The optical-deflection member emits to the outside of the plate a portion of each of the light fluxes from the display having reached the predetermined region, and deflects a portion of each light flux in a predetermined direction by reflection. Thus, a virtual image is formed of the display screen of the image-display element.

### CROSS REFERENCE TO RELATED APPLICATIONS

This application is a continuation application of International Application PCT/JP 2005/001963, filed Feb. 9, 2005, designating the U.S., which claims the benefit of priority from Japanese Patent Application No. 2004-071511, filed on Mar. 12, 2004, and No. 2004-230528, filed on Aug. 6, 2004, the entire contents of which are incorporated herein by reference.

### BACKGROUND

1. Field

The present invention relates to an optical-image display system and an image-display unit mounted to an optical apparatus such as an eyeglass display, a head-mount display, a camera, a portable telephone, a binocular, a microscope, a telescope for forming a virtual image of a display screen of a liquid crystal display, or the like, frontward of an observing eye.

2. Description of Related Art

In recent years, an optical-image display system having a large exit pupil has been proposed (see Japan Unexamined Patent Application Publication No. 2003-536102, for example). The optical-image display system comprises a plurality of half-mirrors arranged in series and having respective transmission optical paths located inside a transmissive plate. The half-mirrors have respective reflective surfaces that are inclined by 45° relative to a surface of the plate. A light flux emitted from a display, such as a display screen of a liquid-crystal display or the like, is made into a parallel light flux. The parallel light flux is incident on the half-mirrors of the optical-image display system by an angle of incidence of 45°. When the light flux from the display is incident on the first half mirror, a portion of the flux is reflected by the half-mirror and another portion transmits through the half-mirror. A portion of the light flux from the display transmitted through the half-mirror is reflected by a next half-mirror, and another portion of the flux transmits through the next half-mirror. This is repeated at each of the respective half-mirrors. The light fluxes from the display, after having been reflected by all the respective half-mirrors, are emitted to outside the plate.

The region outside the plate, to which the respective light fluxes pass, includes a comparatively wide region on which the respective light fluxes emitted from each location on the display screen are incident superposedly. Whenever the pupil of an observing eye is positioned in the region, the eye obtains a focused image of the display screen. That is, the region functions in the same manner as an exit pupil (thus, the region is hereinafter referred to as the “exit pupil”). The exit pupil can easily be enlarged by increasing the number of half-mirrors in the arrangement. A large exit pupil can increase the degrees of freedom with which the pupil of the observing eye can be positioned so that an observer can relaxedly observe the display screen.

However, this optical-image system poses a problem in that it is difficult or complicated to fabricate the plate. For example, to form a half-mirror inside the plate, it is necessary to cut the plate into a large number of pieces, form semi-transparent surfaces on a large number of cut surfaces, and then bond the cut surfaces together.

### SUMMARY

In view of solving the above problem, one object of the present invention is to provide an optical-image display system and an image-display unit of which the plate has a simple structure but still provides a large exit pupil.

Among various aspects of systems and methods as disclosed herein, an embodiment of an optical-image display system includes a light-transmissive plate defining an interior space that can provide an interior optical path for a light flux from a display. The light flux is an integrated flux that comprises component fluxes from each angular field of view of an image-display element of the display. The optical path is configured so that the light flux internally reflects repeatedly as the flux propagates in a forward trajectory path in the interior space. The system includes an optical-deflection member situated in close contact with a predetermined region of one surface of the plate used for internal reflection. As portions of the propagating light flux reach the predetermined region, the portions are deflected, by reflection, in a predetermined direction so as to emit the flux portions to outside the plate. Thus, the optical-image display system forms a virtual image of the display screen of the image-display element.

The deflection characteristic of the optical-deflection member desirably is distributed such that the brightness of the optical flux exiting the plate, as incident at an exit pupil of the system, is uniform.

The system desirably includes a return-reflective surface situated and configured to return the trajectory path of the optical flux, propagating in the forward direction in the plate, so as to reciprocate the optical flux from the display. In such an embodiment the deflection-optical member deflects, in the same direction, a portion of the optical flux propagating along the forward trajectory and a portion of the optical flux propagating along the rearward path.

The return-reflective surface desirably comprises a first reflective surface configured to return the trajectory path of the light flux, passing through the predetermined region inside the plate, within a first angle range. The return-reflective surface also desirably comprises a second reflective surface configured to return the trajectory path of the light flux, passing through the predetermined region, within a second angle range that is different from the first angle range. The first reflective surface can be configured to reflect, in a non-return direction, the light flux passing within the second angle range. The second reflective surface can be configured to return, in the non-return direction, the trajectory path of the optical flux reflected by the first reflective surface. The first reflective surface can be configured to transmit the light flux passing within the second angle range, and the second reflective surface can be configured to return the trajectory path of the light flux transmitted through the first reflective surface.

The first reflective surface and the second reflective surface can be arranged at the same position inside the plate so as to intersect with each other. In this configuration the first reflective surface transmits the light flux passing within the second angle range, and the second reflective surface transmits the light flux passing within the first angle range.

The optical-deflection member can comprise a first optical surface that is situated in close contact with the predetermined region and transmitting to outside the plate a portion of each of the light fluxes that have reached the predetermined region. The optical-deflection member can include a multi-mirror provided on a side of the first optical surface that is opposite to the plate. The multi-mirror can comprise multiple micro-reflective surfaces arranged in a row and inclined to a normal line of the plate. Alternatively, an optical multilayer or an optical-diffraction surface can be used as the micro-reflective surface. Further alternatively, the optical-deflection member can be or comprise an optical-diffraction member.

The optical-deflection member can be configured to transmit at least a portion of an exterior light flux propagating toward the exit pupil. The optical-deflection member can be configured to limit deflection only to light having a wavelength that is substantially the same as the wavelength of the light flux from the display.

The optical-image display system can further be configured to perform a diopter correction to an observing eye arranged at the exit pupil. To such end the optical-image display system can include at least a second plate connected to the internally reflecting plate. In such a configuration the optical-deflection member can be sandwiched between the two plates. A surface of the second plate, opposite the optical-deflection member, can have a curved face for providing at least a portion of the diopter correction.

Various embodiments of the image-display unit can include any of the embodiments of optical-image display systems combined with an image-display element.

Any of the embodiments can provide an optical-image display system and an image-display unit that are of simple structure while providing a large exit pupil.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a perspective view of an eyeglass display according to a first embodiment;

FIG. 2 is a perspective view showing construction and relationship of the image-introduction unit and the optical-image display system of the embodiment of FIG. 1;

FIG. 3 is a horizontal sectional view of the optical-image display system of FIG. 1 and including the image-introduction unit and an observer's eye;

FIG. 4 is an optical diagram showing propagation in the plate 11 of a light flux L from a display 21;

FIG. 5(a) is an optical diagram showing propagation in the plate 11 of the light flux L from the display 21;

FIG. 5(b) is an optical diagram showing propagation in the plate 11 of the light flux L₊ from the display 21;

FIG. 5(c) is an optical diagram showing propagation in the plate 11 of the light flux L₋ from the display 21;

FIGS. 6(a) and 6(b) are enlarged horizontal sectional views of a region of the multi-mirror 12a, in which FIG. 6(a) shows operation of the multi-mirror 12a with regard to the light fluxes L, L₋₂₀, and L₊₂₀ propagating in a “forward” direction from the display, and FIG. 6(b) shows operation of the multi-mirror 12a with regard to the light fluxes L, L₋₂₀, and L₊₂₀ propagating in a “rearward” direction;

FIG. 7(a) shows the light flux L propagating in the forward direction and incident on the exit pupil E;

FIG. 7(b) shows the light flux L propagating in the rearward direction and incident on the exit pupil E;

FIG. 8 depicts a method for correcting the diopter of the eyeglass display;

FIG. 9(a) shows an example in which the incidence region of the light flux L at the face 11-1 on the exterior of the plate 11 becomes discontinuous;

FIG. 9(b) shows an example in which the optical axis of the object lens 22 and liquid-crystal display 21 is inclined;

FIG. 10(a) shows a portion of the multi-mirror 12a′ according to a second embodiment;

FIG. 10(b) shows the configuration of the multi-mirror 12a′;

FIG. 11 depicts a cause for periodic unevenness of brightness of the light flux L from the display, as incident on the exit pupil E in an eyeglass display according to the second embodiment;

FIG. 12 depicts a method for avoiding stepwise unevenness of brightness of the light flux L as incident on the exit pupil E in the eyeglass display according to the second embodiment;

FIG. 13 shows a portion of the multi-mirror 12a″ according to a third embodiment;

FIG. 14 shows operation of the multi-mirror 12a″ with regard to the light fluxes L, L₋₂₀, L₊₂₀ from the display;

FIG. 15(a) depicts an optical diffraction surface 32a that functions similarly to the multi-mirror 12a of the first embodiment;

FIG. 15(b) depicts an optical diffraction surface 32a′ that functions similarly to the multi-mirror 12a′ of the second embodiment;

FIG. 15(c) depicts an optical diffraction surface 32a″ that functions similarly to the multi-mirror 12a″ of the third embodiment;

FIGS. 16(a)-16(c) are respective views depicting various respective methods for diopter correction;

FIG. 17 is a perspective view showing an example in which the optical-image display system 1 is applied to the display of a portable telephone;

FIG. 18 is a perspective view showing an example in which the optical-image display system 1 is applied to a projector;

FIGS. 19(a)-19(b) are respective views depicting the return-reflective surface 11b according to the first embodiment;

FIGS. 20(a)-(e) are respective views depicting a first modified example, a second modified example, a third modified example, a fourth modified example, and a fifth modified example of the first embodiment;

FIGS. 21 (a)-21(d) are respective views depicting a sixth modified example of the first embodiment;

FIG. 22 is a graph of reflectance (%) versus wavelength (nm) exhibited by the reflective-transmissive surface 13a of Example 1, for vertically incidence light;

FIG. 23 is a graph of reflectance versus wavelength exhibited by the reflective-transmissive surface 13a of Example 1, for light incident at 60°;

FIG. 24 is a graph of reflectance versus wavelength exhibited by the first reflective-transmissive surface 12a-1 of Example 2, for vertically incident light;

FIG. 25 is a graph of reflectance versus wavelength exhibited by the first reflective-transmissive surface 12a-1 of Example 2, for light incident at 60°;

FIG. 26 is a graph of reflectance versus wavelength exhibited by the other first reflective-transmissive surface 12a-1 of Example 2, for vertically incident light;

FIG. 27 is a graph of reflectance versus wavelength exhibited by the other first reflective-transmissive surface 12a-1 of Example 2, for light incident at 60°;

FIG. 28 is a graph of reflectance (transmittance) versus wavelength exhibited by the second reflective-transmissive surfaces 12a-2, 12a-2′ of Example 3, for light incident at 30° (film thickness 10 nm);

FIG. 29 is a graph of reflectance (transmittance) versus wavelength exhibited by the second reflective-transmissive surfaces 12a-2, 12a-2′ of Example 3, for light incident at 30° (film thickness 20 nm);

FIG. 30 is an emission-spectrum distribution for the liquid-crystal display 21;

FIG. 31 is a graph of reflectance (transmittance) versus wavelength exhibited by the second reflective-transmissive surfaces 12a-2, 12a-2′ (3-band mirror), for light incident at 30°;

FIG. 32 is a graph of reflectance (transmittance) versus wavelength exhibited by the second reflective-transmissive surfaces 12a-2, 12a-2′ (polarization beam-splitter type mirror), for light incident at 30°;

FIG. 33 is respective graphs of reflectance versus wavelength exhibited by the return-reflective surface 11b″ of Example 6, for vertically incident light and for incident p-polarized light;

FIG. 34 is a table of data pertaining to the construction of the return-reflective surface 11b″ of Example 6′;

FIG. 35 provides respective graphs of reflectance versus wavelength exhibited by the return-reflective surface 11b″ of Example 6′, for vertically incident light and for p-polarized light incident at 60°;

FIG. 36 is a table of data pertaining to the construction of the return-reflective surface 11b″ of Example 7;

FIG. 37 provides respective graphs of reflectance versus wavelength exhibited by the return-reflective surface 11b″ of Example 7, for vertically incident light and for p-polarized light incident at 60°; and

FIG. 38 depicts an embodiment of a method for forming the holographic surface used in Example 8.

### DESCRIPTION OF THE PREFERRED EMBODIMENTS

Best modes (embodiments) of the invention are described as follows.

### First Embodiment

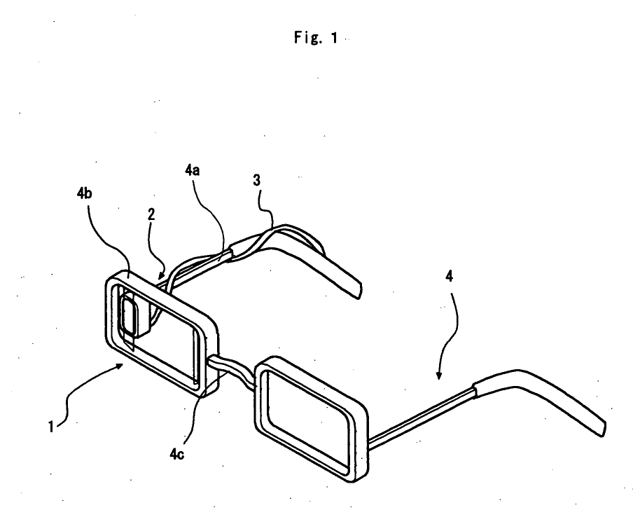

A first embodiment of the invention is described with reference to FIGS. 1-8. This embodiment pertains to an eyeglass display.

First, the configuration of the eyeglass display is described. As shown in FIG. 1, the eyeglass display includes an optical-image display system 1, an image-introduction unit 2, and a cable 3. The optical-image display system 1 and the image-introduction unit 2 are supported by a support member 4 (including temples 4a, a rim 4b, and a bridge 4c). The support member 4 is similar to a frame for eyeglasses that is mountable to the head of an observer.

The optical-image display system 1 has an outer shape similar to an eyeglass lens and is supported by the surrounding rim 4b. The image-introduction unit 2 is supported by the temple 4a. The image-introduction unit 2 is supplied with an image signal and power from an external apparatus by way of the cable 3.

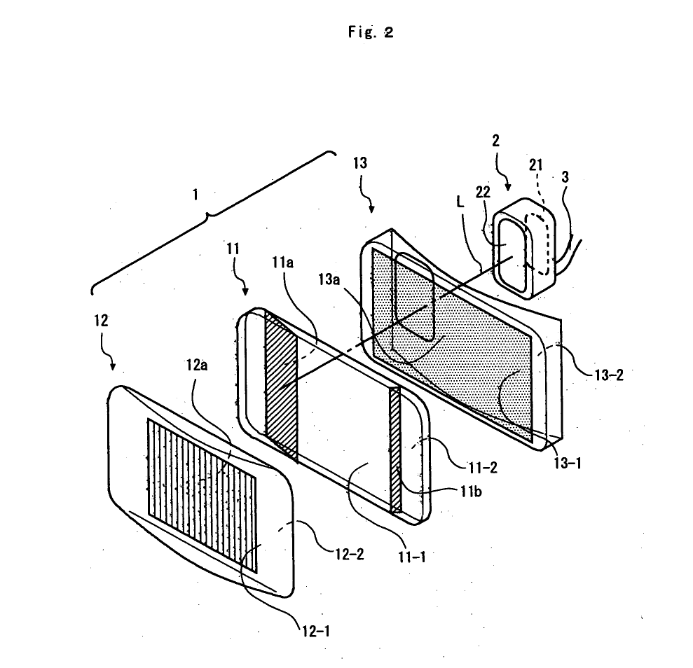

As mounted, the optical-image display system 1 is situated frontward from one of the observer's eyes (assumed to be a right eye, hereinafter, referred to as “observing eye”). In the following, the eyeglass display is described from the perspective of the observer and the observing eye. As shown in FIG. 2, the image-introduction unit 2 comprises a liquid-crystal display 21 for displaying the image based on the image signal, and an objective lens 22 having a focal point in the vicinity of the liquid-crystal display 21.

The image-introduction unit 2 emits a light flux L (specifically the light flux L is emitted from the display 21). The light flux L passes, on the observer side, through the objective lens 22 to the right-end portion of a face of the optical-image display system 1.

The optical-image display system 1 comprises plates 13, 11, 12 arranged in this order from the observer side. These plates are in close contact with each other. Each plate 13, 11, 12 is transmissive to at least visible light from the exterior side directed to the observing eye (the “exterior side” is the region faced by the side of the optical-image display system 1 that is opposite the observer side). The plate 11 interposed between the two plates 13, 12 is a parallel flat plate that internally reflects the light flux L introduced to the plate 11 from the display. This internal reflection occurs repeatedly from the surface 11-1 on the exterior side and from the surface 11-2 on the observer side. The plate 12 is situated on the exterior side of the plate 11, and mainly deflects part of the light flux L, as the flux is being internally reflected in the plate, in the observer direction. The plate 12 also performs a respective portion of the diopter correction of the observing eye. To such end the plate 12 is a lens having a flat surface 12-2 facing the observer side. The plate 13 is situated on the observer side of the plate 11 and performs a respective portion of diopter correction of the observing eye. To such end the plate 13 is a lens having a flat surface 13-1 facing the exterior side.

The interior of the plate 11, on which the light flux L is first incident, includes a reflecting surface 11 a for deflecting the incoming light flux L at an angle allowing internal reflection of the light flux in the interior of the plate.

The surface 12-2 of the plate 12 on the observer side includes a multi-mirror 12a, details of which will be described later.

In the interior of the plate 11, another region, which is remote from the image-introduction unit 2, includes a return-reflective surface 11b. The return-reflective surface has a normal line extending in a direction that is substantially the same as the propagation direction of the light flux L from the reflecting surface 11a.

The exterior-side surface 13-1 of the plate 13 includes a reflective-transmissive surface 13a that functions similarly to an air gap. The reflective-transmissive surface 13a exhibits high reflectivity to light incident thereto at a comparatively large angle of incidence, and exhibits high transmissivity to light incident thereto at a small angle of incidence (i.e., substantially vertically). After forming the reflective-transmissive surface 13a, the strength of the optical-image display system 1 can be improved by bonding together the plate 13 and the plate 11 while maintaining the internal-reflection capability of the plate 11.

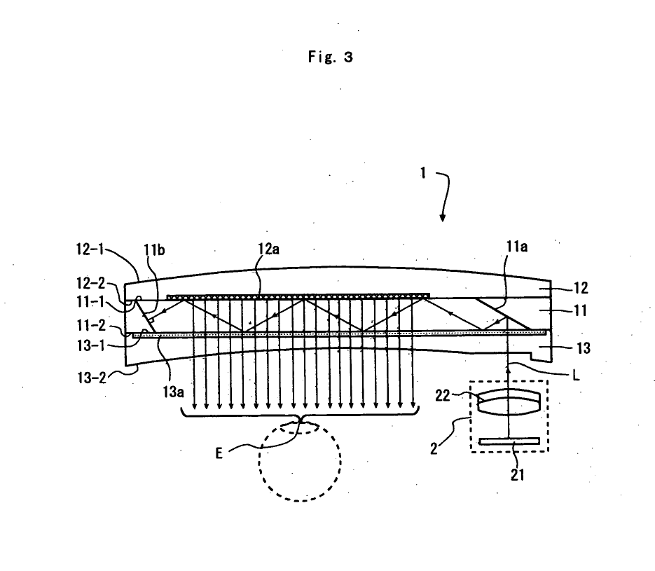

Next, the configurations of the respective surfaces of the optical-image display system 1 are described in connection with the propagation behavior of the light flux L from the display. As shown by FIG. 3, the light flux L (represented as coming from the display along a center angular field of view) is emitted by the display screen of the liquid-crystal display 21. The light flux L is collimated by the objective lens 22. The light flux L passes through the plate 13 and into the interior of the plate 11. The region on the observer-side surface 13-2 of the plate 13, through which the light flux L passes, is flat and provides no optical power to the light flux L.

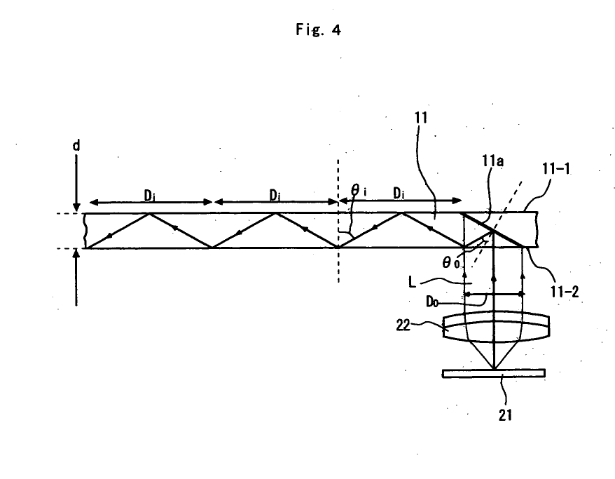

As shown in FIG. 4, the light flux L is incident on the reflecting surface 11a inside the plate 11 at a predetermined angle of incidence θ₀. The light flux L reflected from the reflecting surface 11a is incident on the observer-side surface 11-2 of the plate 11 at a predetermined angle of incidence θᵢ. The angle of incidence θᵢ is larger than the critical angle θ_{c} of internal reflection of the plate 11. The reflective-transmissive surface 13a (refer to FIG. 3) is in contact with the observer-side surface 11-2 of the plate 11 and functions similarly to an air gap. The light flux L is internally reflected by the observer-side face 11-2 and by the exterior-side surface 11-1. These internal reflections are repeated alternately as the light flux propagates to the left in the figure, away from the image-introduction unit 2.

The width Dᵢ, in the left and right directions, of the light flux L as internally reflected in the plate 11 is represented by Equation (1), in which D₀ is the diameter of the light flux L as incident on the plate 11, d is the thickness of the plate 11, and θ₀ is the angle of incidence of the light flux L on the reflecting surface 11a:
Dᵢ=D₀+d/tan(90°−2θ₀) (1)
The following description assumes that the angle of incidence of the light flux L on the reflecting surface 11a is θ₀=30°. The thickness of the plate 11 is d=D₀ tan θ₀, and the angle of incidence θᵢ of the internal reflection is θᵢ=60°. By Equation (1), the width Dᵢ of the light flux L as internally reflected is double the diameter D₀ of the light flux L as incident on the plate 11. Thus, all respective incidence regions of the light flux L on the exterior-side surface 1 1-1 and all respective incidence regions of the light flux L on the observer-side surface 11-2 of the plate 11 are continuously aligned with each other without any intervening gaps.

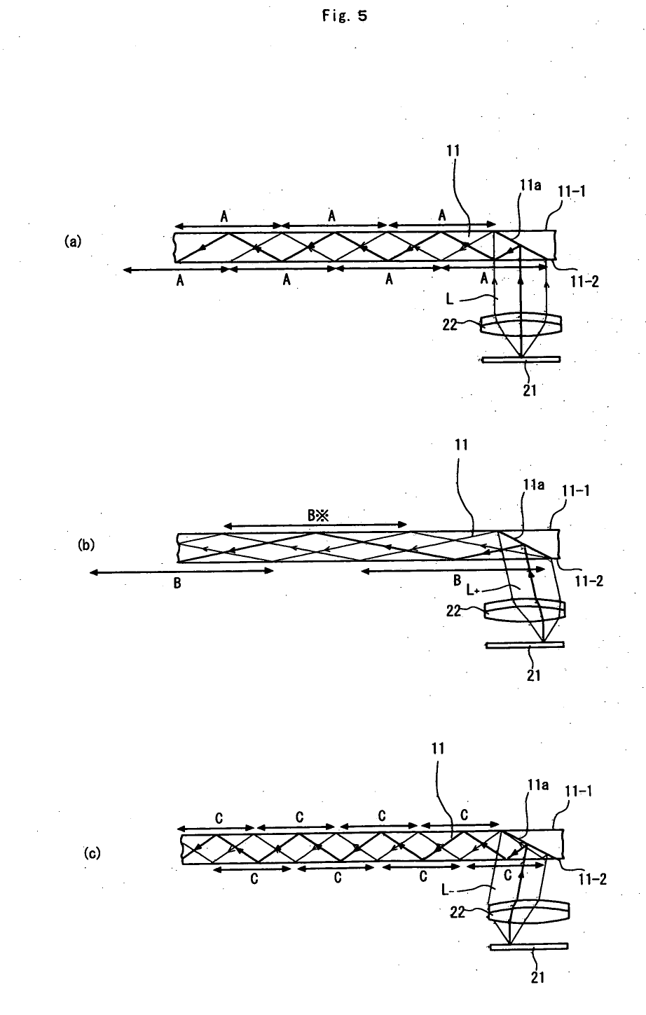

The foregoing description has addressed only the light flux L of the center angular field of view of the display screen of the liquid-crystal display 21. However, as shown in FIGS. 5(a)-5(c), other light fluxes L₊, L₋, etc., of respective peripheral angular fields of view also propagate inside the plate 11 at angles of incidence θᵢ, along with the light flux L of the center angular field of view. The light fluxes L₊, L₋ of peripheral angular fields of view are different from each other. FIG. 5(a) shows the light flux L of the center angular field of view, and FIGS. 5(b)-5(c) show the light fluxes L₊, L₋ of the peripheral angular fields of view, respectively.

The notation “A” in FIG. 5(a) represents each region on which the light flux L of the center angular field of view is incident on the exterior-side surface 11-1 and on the observer-side surface 11-2 of the plate 11. The notation “B” in FIG. 5(b) represents each region on which the light flux L₊ of the peripheral angular field of view is incident on the exterior-side surface 11-1 and on the observer-side surface 11-2 of the plate 11. The notation “C” in FIG. 5(c) represents each region on which the light flux L₋ of the peripheral angular field of view is incident on the exterior-side surface 11-1 and on the observer-side surface 11-2 of the plate 11. On the exterior-side surface 11-1, the light fluxes L, L₊, L₋ are respectively incident within a region denoted B*. The region in which the multi-mirror 12a of FIG. 3 is formed is intended to cover the region B*.

Referring back to FIG. 3, the propagation behavior of the light fluxes L, L₊, L₋ is now described. Hereinafter, the light fluxes from the display at all the respective angular fields of view are designated collectively by L. These light fluxes L are deflected to the observer side while maintaining their respective angular relationships among the various angular fields of view by respective predetermined respective rates of incidence on the multi-mirror 12a. The deflected light fluxes L of the respective angular fields of view are incident on the observer-side surface 11-2 by angles that are less than the critical angle θ_{c} of internal reflection of the plate 11. Thus, these light fluxes L are transmitted through the observer-side surface 11-2 of the plate 11 and through the reflective-transmissive surface 13a. Thus, the light fluxes L are incident, by way of the plate 13, on the region E in the vicinity of the observing eye. That is, the light fluxes L of the respective angular fields of view, superposed and incident in the region B* (refer to FIG. 5), are superposed and incident on the region E while maintaining their respective angular relationships among the angular fields of view.

The region E constitutes an exit pupil of the optical-image display system 1. Placing the pupil of the observing eye anywhere in the exit pupil E enables the observing eye to observe a virtual image of the display screen of the liquid-crystal display 21.

According to the eyeglass display of the embodiment, the region B* (refer to FIG. 5) and the region of the multi-mirror 12a are sufficiently larger than the pupil of the observing eye to ensure the large exit pupil E.

The return-reflective surface 11b inside the plate 11 return-reflects the light flux L that has propagated forwardly through the interior of the plate 11. The return-reflected light propagates in a reverse direction (also called “rearwardly”) to the forwardly propagating light. Thus, the light flux L is reciprocated inside the plate 11. Also, the light flux L propagating rearwardly is deflected similarly to the light flux L propagating forwardly at each point of incidence on the multi-mirror 12a. These light fluxes reflected by the multi-mirror 12a pass through the reflective-transmissive surface 13a to the exit pupil E via the plate 13.

Next, descriptions are provided of exemplary respective methods for fabricating the plate 11, the plate 12, and the plate 13.

To fabricate the plate 11, a plate of optical glass, optical plastic, or the like is fabricated. The plate is cut in a skewed manner at two locations, yielding two pairs of cut faces. (One location corresponds to the intended location and angle of the surface 11a, and the other location corresponds to the intended location and angle of the surface 11b.) The cut faces are optically polished. Then, one face of each pair is coated with multilayered films of aluminum, silver, and a dielectric material, as required, to form respective reflective faces. Then, the respective cut faces are bonded back together. One face of one of the bonded pair of faces is the reflecting surface 11a and one face of the other bonded pair of faces is the return-reflective surface 11b. In each pair, the particular face that is coated is selected with consideration given to the number of fabricating steps or cost involved.

Instead of cutting the plate 11 into separate pieces in the manner described above, the pieces can be prepared separately and bonded together after coating. The choice of cutting a single plate or forming the pieces separately is made with consideration given to the number of fabricating steps or cost involved. For example, optical glass, of which both ends are cut in a skewed manner and polished, can be prepared, with reflective films applied to each skewed end. The final shape of the complete plate can be achieved using supplementing plastic. Alternatively, both ends may remain exposed in their skewed states without adding optical material to complete the entire plate-like shape (this configuration does not hinder the function of the optical system).

To fabricate the plate 12, a transmissive plate (lens) having a flat surface on one face and a curved surface on the other face is prepared. The curved face is the exterior-side surface 12-1, and the flat face is the observer-side surface 12-2. The multi-mirror 12a is formed on the observer-side surface 12-2, by a method described later.

To fabricate the plate 13, a transmissive plate (lens) having a flat surface on one face and a curved surface on the other face is prepared. An optical multilayer, intended to function similarly to an air gap, is formed on the flat surface to form the reflective-transmissive surface 13a.

In the following example, assume that a general optical glass BK7 (refractive index n_{g}=1.56) is used as a material of the plate 11. Generally, the critical angle θ_{c} is represented by Equation (2) with regard to a difference of refractive indices n_{g} between the plate 11 and the material of the reflective surface:
θ_{c}=arcsin(1/n_{g}) (2)
Accordingly, when made of this material, the critical angle θ_{c} of the plate 11 is 39.9°.

As described above, the angle of incidence of the light flux L of the center angular field of view is θᵢ=60°. At this angle of incidence, the plate 11 can propagate all the respective light fluxes L that are incident with the angle range of θᵢ=40°−80°, that is, the respective light fluxes L₋₂₀ through L₊₂₀ within a range of an angular field of view of −20° through +20°in the left and the right direction of the observer.

The surface 13-1 of the plate 13 may be formed with an optical-diffraction surface (holographic surface or the like) in place of the optical multilayer. In such an instance, the condition under which the optical-diffraction surface exhibits diffraction can be adjusted so as to be the same as the corresponding characteristic of the optical multilayer mentioned above. When using an optical-diffraction surface, the condition does not have to satisfy a critical angle.

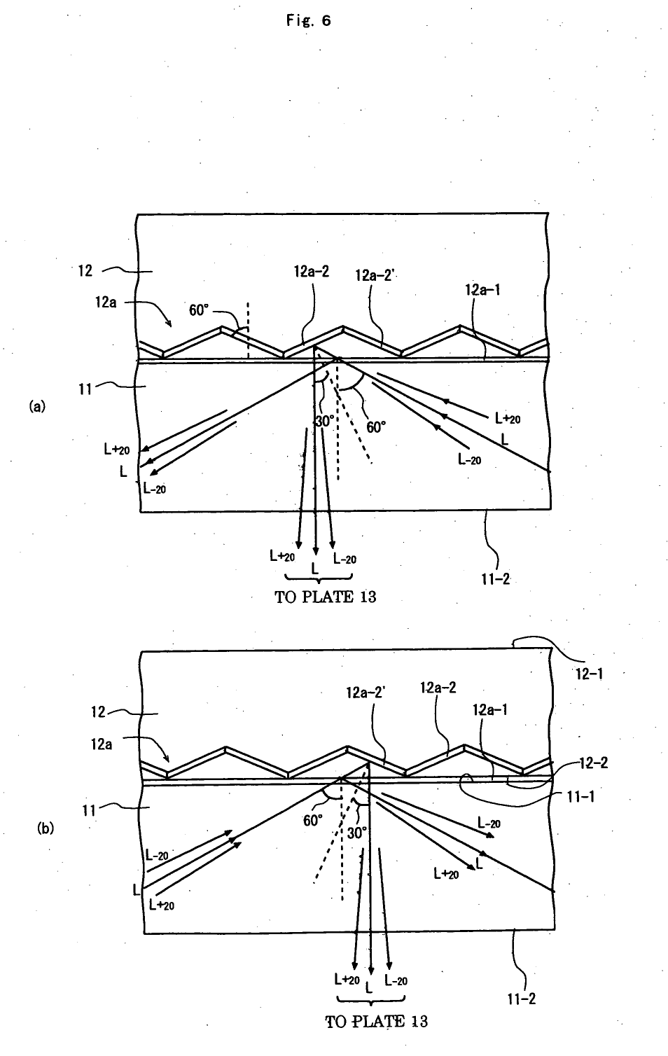

Next, a configuration of the multi-mirror 12a is described. As shown in FIGS. 6(a) and 6(b), the multi-mirror 12a includes a first reflective-transmissive surface 12a-1. Multiple small, second reflective-transmissive surfaces 12a-2, 12a-2′ are arranged inside the plate 12 in a row-like manner with the surfaces being alternately inclined rightward and leftward, respectively, relative to the observer and without any intervening gaps. The inclinations of the second reflective-transmissive surfaces 12a-2, 12a-2′ are at respective angles that are equal but opposite in direction. More specifically, the angle made by each second reflective-transmissive surface 12a-2 and a normal line of the plate 12, and the angle made by each second reflective-transmissive surface 12a-2′ and the normal line of the plate 12 are respectively 60°. If the multi-mirror 12a is cut in a horizontal plane (parallel to the paper surface of FIG. 6), the resulting sectional shapes are of an isosceles triangle having a base angle of 30°.

The first reflective-transmissive surface 12a-1 reflects light incident thereon at an angle of incidence in the vicinity of 60° (40°-80°). This surface 12a-1 transmits light incident thereon at an angle of incidence in the vicinity of 0° (−20°-+20°). The second reflective-transmissive surfaces 12a-2, 12a-2′ reflect light incident thereon at an angle of incidence of the vicinity of 30°(10°-50°), while transmitting other light.

If the plate 12 is made of optical glass, optical resin, fused quartz, or the like, an optical multilayer can be combined with, for example, a dielectric member, a metal, an organic material, or the like having different respective refractive indices. This multilayer can be applied to the first reflective-transmissive surface 12a-1 and the second reflective-transmissive surfaces 12a-2, 12a-2′.

During design, the angular criteria for reflectance and transmittance of the first reflective-transmissive surface 12a-1 and of the second reflective-transmissive surfaces 12a-2, 12a-2′ are optimized with consideration given to the desired number of internal reflections. Desirably a balance (see-through clarity) is achieved of respective intensities of light flux from the exterior and light flux L from the display as incident on the exit pupil E.

Although FIGS. 6(a) and 6(b) show an embodiment in which the first reflective-transmissive surface 12a-1 and the second reflective-transmissive surfaces 12a-2, 12a-2′ are proximal to each other, in an alternative embodiment intervals may be provided therebetween.

Next, an example method for fabricating the multi-mirror 12a is described. Multiple small, mutually aligned grooves having V-shaped sections are formed without gaps therebetween on the face 12-2 on the observer side of the material of the plate 12. Optical multilayers for forming the second reflective-transmissive surfaces 12a-2, 12a-2′ are respectively formed on the inner walls of each groove. The grooves are then filled with a material that is similar to the plate material. An optical multilayer, intended to be the first reflective-transmissive surface 12a-1, is then formed on the observer-side surface of the plate 12. The grooves and optical multilayers can be formed by a combination of resin molding, vapor deposition, or the like.

Next, operation of the multi-mirror 12a is described with regard to the light flux L propagating inside the plate 11. A representative example involves a light flux L of the center angular field of view having θᵢ=60°, the light flux L₋₂₀ of the peripheral angular field of view having θᵢ=40°, and the light flux L₊₂₀ of the peripheral angular field of view having θᵢ=80°. In propagating forwardly, as shown in FIG. 6(a), the light fluxes L, L₋₂₀, L₊₂₀, internally reflected in the interior of the plate 11 at respective angles of incidence in the vicinity of 60° (i.e., 40° to 80°), are not totally reflected at the boundary face of the plate 11 and the first reflective-transmissive surface 12a-1. Rather, a portion of this incident flux transmits through the first reflective-transmissive surface 12a-1 to inside the plate 12 where the light fluxes L, L₋₂₀, L₊₂₀ are respectively incident on the second reflective-transmissive surface 12a-2 at respective angles of incidence in the vicinity of 30° (i.e., 10° to 50°). The light fluxes L, L₋₂₀, L₊₂₀ incident on the second reflective-transmissive surface 12a-2 are reflected by the second reflective-transmissive surface 12a-2 toward the first reflective-transmissive surface 12a-1 where they are incident at respective angles of incidence in the vicinity of 0° (i.e., −20° to +20°). These fluxes thus are transmitted into the plate 11 by passing through the first reflective-transmissive surface 12a-1. The angle of incidence at this time is smaller than the critical angle θ_{c} so that the light fluxes L, L₋₂₀, L₊₂₀ transmit through the plate 11 without being internally reflected, and are emitted to the outside through the plate 13.

In propagating rearwardly, as shown in FIG. 6(b), not the light fluxes L, L₋₂₀, L₊₂₀ internally reflected by the plate 11 at an angle of incidence in the vicinity of 60° (i.e., 40° to 80°) are totally reflected by the boundary of the plate 11 with the first reflective-transmissive surface 12a-1. Rather, portions of the fluxes are transmitted through the first reflective-transmissive surface 12a-1 to inside the plate 12. These transmitted light fluxes L, L₋₂₀, L₊₂₀ are respectively incident on the second reflective-transmissive surface 12a-2′ by an angle of incidence in the vicinity of 30° (i.e., 10° to 50°). The light fluxes L, L₋₂₀, L₊₂₀ incident on the second reflective-transmissive surface 12a-2′ are reflected thereby toward the first reflective-transmissive surface 12a-1 where they are incident at an angle in the vicinity of 0° (i.e., −20° to +20°). Thus, these fluxes enter the plate 11 by transmission through the first reflective-transmissive surface 12a-1. The angle of incidence at this time is smaller than the critical angle θ_{c} so that the light fluxes L, L₋₂₀, L₊₂₀ pass through the plate 11 without being internally reflected, and thus are emitted to the outside via the plate 13.

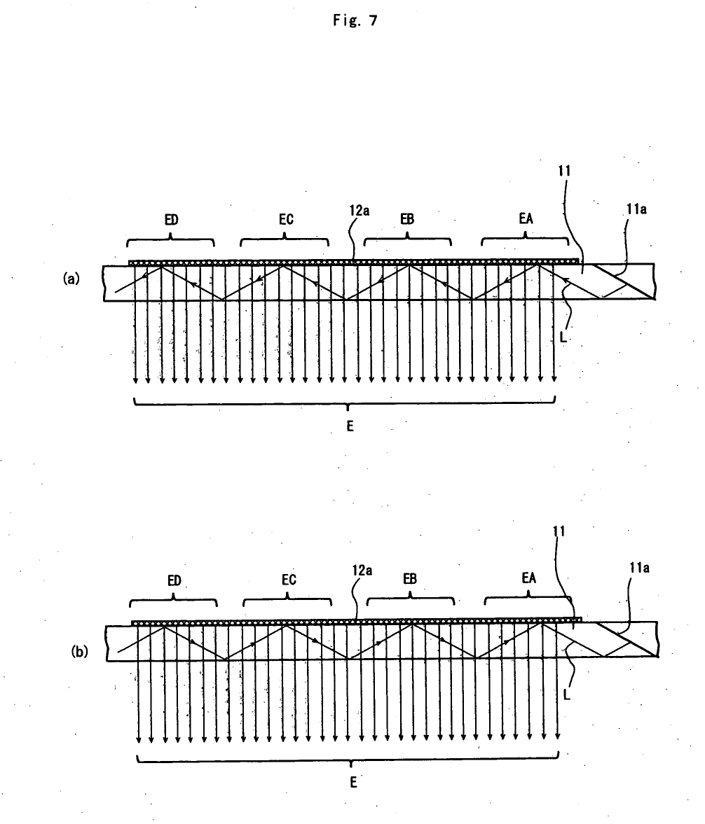

Next, an explanation will be given of an effect caused by the plate 11 being provided with the return-reflective surface 11b for light-flux reciprocation and the multi-mirror 12a being provided with two second reflective-transmissive surfaces 12a-2, 12a-2′. As shown in FIG. 7(a), in propagating forwardly through the interior of the plate 11, the light flux L that is repeatedly incident on the multi-mirror 12a reaches the second reflective-transmissive surface 12a-2 (refer to FIG. 6(a)) in the multi-mirror 12a with constant intensity at each incidence on the multi-mirror 12a. This flux is deflected toward the exit pupil E. By way of example, assume the total number of incidences of the forwardly propagating light flux L on the multi-mirror 12a, is four. Assume also that the deflection efficiency of the multi-mirror 12a with regard to the light flux L (wherein deflection efficiency is the ratio of brightness of the light flux L deflected in the direction of the exit pupil E to brightness of the light flux L incident on the multi-mirror 12a) is 10% (yielding an internal reflectance of 90%). Let the regions of incidence of the light flux L in the multi-mirror 12a be designated EA, EB, EC, ED successively from the right side of the observer. The relative brightnesses of the light flux L incident on the exit pupil E from the respective regions, as the flux propagates forwardly, are as follows (disregarding loss of light by absorption):
EA: 0.1
EB: 0.09
EC: 0.081
ED: 0.0729
   Thus, the more proximate the region to the return-reflective surface 11b, the weaker the brightness of the light flux L incident on the exit pupil E from that region. Therefore, a stepwise drop in brightness is realized in the light flux L incident on the exit pupil E as the flux propagates forwardly inside the plate 11.

On the other hand, as shown in FIG. 7(b), while propagating rearwardly from the return-reflective surface 11b, the light flux L repeatedly incident on the multi-mirror 12a reaches the second reflective-transmissive surface 12a-2′ (refer to FIG. 6(b)) in the multi-mirror 12a with constant intensity at each incidence on the multi-mirror 12a. This flux is deflected toward the exit pupil E. By way of example, assume the reflectance of the return-reflective surface 11b is 100%. Assume also that the relative brightnesses of the light flux L as incident on the exit pupil E from the respective regions as the flux propagates rearwardly are as follows (disregarding loss of light by adsorption):
EA: 0.047
EB: 0.0531
EC: 0.059
ED: 0.0651
   Thus, the more remote the region from the return-reflective surface 11b, the less the brightness of the light flux L incident on the exit pupil E from the region. Therefore, a stepwise decline in brightness is realized in the light flux L incident on the exit pupil E as the flux propagates rearwardly in the plate 11.

However, the light fluxes L that have propagated forwardly and rearwardly are simultaneously incident on the exit pupil E. Hence, the relative brightnesses of the light flux L incident on the exit pupil E from the respective regions are respective sums of brightnesses realized during the forward propagation and the rearward propagation, as follows:
EA: 0.147
EB: 0.1431
EC: 0.140
ED: 0.138
   Thus, no stepwise unevenness of brightness actually occurs. Furthermore, since the multi-mirror 12a is configured such that the second reflective-transmissive surfaces 12a-2 and the second reflective-transmissive surfaces 12a-2′ have similar characteristics, since these surfaces are arranged without intervening gaps, and since the multi-mirror 12a produces a uniform characteristic to external light flux directed to the exit pupil E, the multi-mirror does not cause any significant unevenness of the brightness of the external light flux as incident on the exit pupil E.

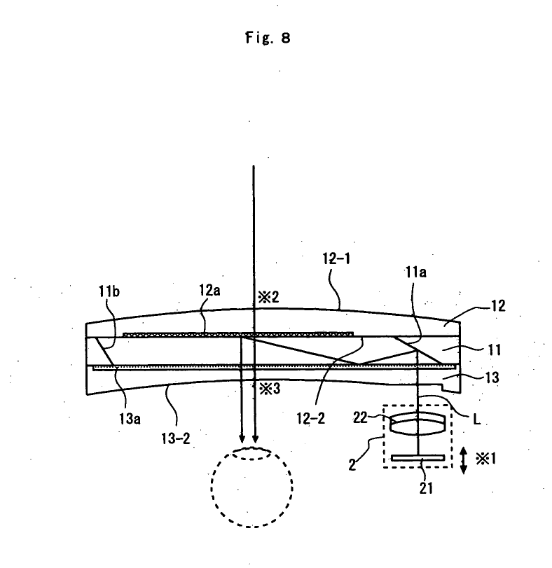

Next, the diopter corrections are described. As shown in FIG. 8, the observer-side surface 13-2 of the plate 13 and the exterior-side surface 12-1 of the plate 12 are curved. In addition, the position of the objective lens 22 along its optical axis can be changed. Correction of the near diopter scale (of the observing eye relative to the virtual image of the display screen of the liquid-crystal display 21) can be performed by optimizing a combination of a position (*1) of the objective lens 22 in the optical-axis direction and the curvature (*3) of the observer-side surface 13-2. On the other hand, correction of the remote diopter scale (of the observing eye relative to an exterior image) can be performed by optimizing a combination of the curvature (*2) of the exterior-side surface 12-1 of the plate 12 and the curvature (*3) of the observer-side surface 13-2 of the plate 13.

Alternatively, without changing the position of the objective lens 22 at all, correction of the remote diopter scale (of the observing eye relative to an exterior image) may be performed mainly by optimizing the curvature (*2) of the exterior-side surface 12-1, and correction of a limited-distance diopter scale (of the observing eye relative to the virtual image of the display screen) may be performed mainly by optimizing the curvature (*3) of the observer-side surface 13-2.

Since, in this embodiment, the multi-mirror 12a is formed only on one surface (the observer-side surface 12-2) of the plate 12, another surface (the exterior-side surface 12-1) also can be utilized for diopter correction. The diopter correction of the observing eye relative to the virtual image of the display screen can be performed independently of the diopter correction of the observing eye relative to the exterior image. Accordingly, it is possible to carry out fine diopter corrections in accordance with not only a characteristic of the observing eye (degree of nearsightedness, farsightedness, presbyopia, astigmatism, or weak eyesight) but also a circumferential usage condition of the eyeglass display.

The curved faces of the exterior-side surface 12-1 of the plate 12 and the observer-side surface 13-2 on the observer side of the plate 13 can have various profiles such as spherical, rotationally symmetrical aspherical, curved surface having radii of curvature that differ in the up-down direction versus left-right direction of the observer, or a curved surface having a radius of curvature that differs by a position, or the like.

In the foregoing methods, instead of changing the axial position of the objective lens 22, the axial position of the liquid-crystal display 21 or the focal length of the objective lens 22 may be optimized. Also, whenever sufficient diopter correction can be performed by altering the plate 12, the plate 13 can be omitted by introducing the light flux L from the display to the plate 11 in a manner by which the light flux L is totally reflected by the inner surface of the plate 11.

Next, an effect of the eyeglass display is described. The eyeglass display of this embodiment ensures the large exit pupil E by combining the plate 12 (including the multi-mirror 12a) with the plate 11 for internal reflection. Thus, the inner configuration of the plate 11 can be extremely simple. The multi-mirror 12a described above is composed of very small repetitive units, and has a simple shape. Hence, to fabricate the multi-mirror 12a on the plate 12, it is not necessary to cut the plate 12 into a number of pieces. As described above, a mass-production fabrication technique can be used such as resin molding, vapor deposition, or the like. Thus, the eyeglass display can provide a large exit pupil E with a simple and easy-to-manufacture configuration of the eyeglass display.

To introduce the light flux L from the liquid-crystal display to the eye of the observer, the light flux L from the display is deflected by reflection from the multi-mirror 12a in the direction of the pupil so that the image of the display screen of the liquid crystal display 21 is focused on the retina of the observing eye of the observer without chromatic aberration.

This embodiment of the eyeglass display uses the multi-mirror 12a, the return-reflective surface 11b, and the second reflective-transmissive surfaces 12a-2, 12a-2′ for light-flux reciprocation so that brightness variation of the light flux L from the display as incident on the exit pupil E is prevented. Also, since the multi-mirror 12a shows a characteristic transmittance uniformity to exterior light flux, the multi-mirror does not impart brightness variation to the exterior light flux incident on the exit pupil E, either. The brightness distribution of the exterior light flux, as incident on the exit pupil E, is unrelated to the density with which the unit-mirrors of the multi-mirror 12a are arranged. Accordingly, even if the configuration of the multi-mirror 12a is simplified by enlarging the unit-mirrors to some degree, the brightness of the exterior light flux as incident on the exit pupil E is kept substantially uniform.

In the eyeglass display, the multi-mirror 12a is formed on the observer-side surface 12-2 of the plate 12. This allows the shape of the curved face (*2 in FIG. 8) of the exterior-side surface 12-1 to be freely set, which can increase the degrees of freedom with which diopter correction can be made. For example, diopter correction of the observing eye relative to the virtual image of the display screen of the liquid-crystal display 21 and diopter correction of the observing eye relative to an exterior image can be made independently from each other.

### Modified First Embodiment

If the light source of the liquid-crystal display 21 is a narrow-band LED or the like, or if the light source produces only a specific polarization component, these parameters can be taken into consideration. Thus, the reflection characteristic of the first reflective-transmissive surface 1 2a-1, the second reflective-transmissive surfaces 12a-2, 12a-2′ can be optimized with regard to the wavelength or the direction of polarization of the light flux.

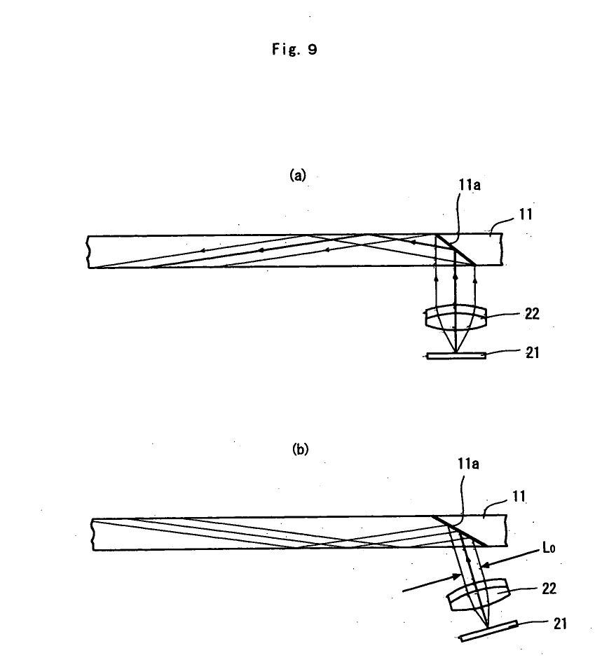

According to the example embodiment described above, the angle of incidence of the light flux L on the reflective surface 11a is θ₀=30°, and the thickness of the plate 11 is d=L₀ tan θ₀. The width Lᵢ of the light flux L in the internal reflection is twice the diameter L₀ of the light flux L as incident on the plate 11. Also, the respective incidence regions of the light flux L at the exterior-side surface 11-1 of the plate 11 and the respective incidence regions of the light flux L on the observer-side surface 11-2 of the plate 11 are all aligned continuously without gaps therebetween. However, these parameters are not intended to be limiting. Rather, these parameters desirably are set in accordance with the intended-use specification of the eyeglass display. For example, as shown by FIG. 9(a), the respective incidence regions of the light flux L at the exterior-side surface 11-1, and the respective incidence regions of the light flux L at the observer-side surface 11-2 may be made discontinuous.

As shown in FIG. 9(b), the optical axis of the objective lens 22 and liquid-crystal display 21 may be inclined to the normal line of the plate 11. In that case, the effective angle of incidence of the flux to the reflective surface 11a can be increased without increasing the diameter of the light flux L. Also, the width Lᵢ of the light flux L that is internally reflecting can be increased without increasing the thickness of the plate 11.

In the embodiment of an eyeglass display described above, the observing eye is the right eye of the observer, and the light flux L is introduced by the image-introduction unit 2 rightward of the observing eye. However, if the observing eye is the left eye of the observer, and the light flux L is introduced leftward of the observing eye, the various reflective surfaces discussed above may simply be arranged in an inverted manner in the left and right directions.

### Second Embodiment

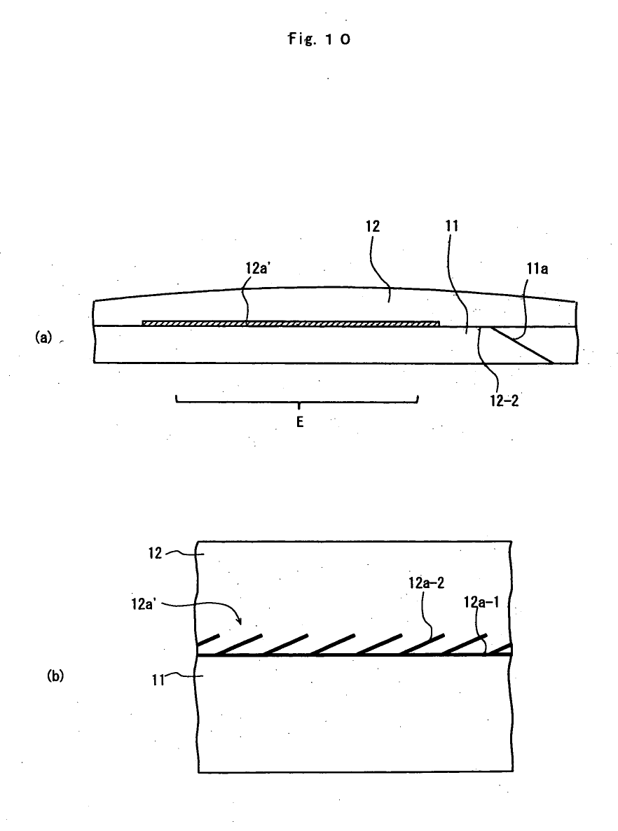

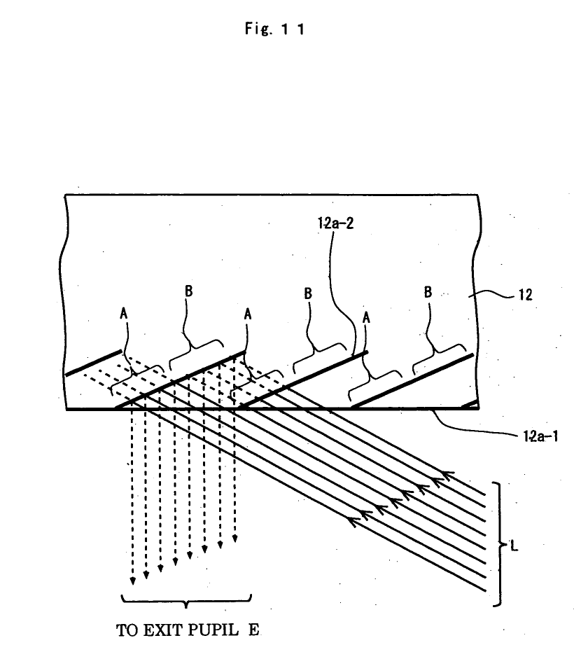

A second embodiment is described below in reference to FIGS. 10 and 11. This embodiment is directed to an eyeglass display, of which only the point of difference from the first embodiment is described. The point of difference is that the return-reflective surface 11b of the first embodiment is omitted, and a multi-mirror 12a′ is provided in place of the multi-mirror 12a. As shown in FIG. 10(a), the multi-mirror 12a′ is disposed on the surface 12-2 on the observer side of the plate 12, similar to the multi-mirror 12a in the first embodiment. The multi-mirror 12a′ corresponds to the multi-mirror 12a, except that the second reflective-transmissive surface 12a-2′ is omitted and the second reflective-transmissive surfaces 12a-2 are arranged densely in the manner shown in the enlargement of FIG. 10(b). Since the return-reflective surface 11b is omitted, the light flux L from the display is not reciprocated inside the plate 11. But, the forwardly propagating light flux L from the display behaves similarly to the forwardly propagating flux in the first embodiment.

The multi-mirror 12a′ acts on the light fluxes L, L₋₂₀, L₊₂₀ from the display similarly to the light flux propagating forwardly in the first embodiment (FIG. 6(a)). Such an eyeglass display, substantially similar to the eyeglass display of the first embodiment, provides a large exit pupil E but with a simple construction.

### Modified Second Embodiment

In the second embodiment, two kinds of brightness unevenness can remain in the light flux L as incident on the exit pupil E. First, since the light flux L is not reciprocated inside the plate 11, brightness unevenness is exhibited in the units of light flux L incident on the exit pupil E. Second, as shown in the enlarged view of FIG. 11, a region B is located on the second reflective-transmissive surface 12a-2. The region B has substantially half the size of the corresponding first reflective-transmissive surface 12a-1 and is located remotely to the first reflective-transmissive surface 12a-1. The region B is shaded by the second reflective-transmissive surface 12a-2 adjacent thereto on the right side as seen from the observer. As a result of this shading, the amount of the light flux L reaching the region B is smaller than the amount of light reaching the region A. Hence, the amount of the light flux L directed from the region B to the exit pupil E is smaller than the amount of the light flux directed from the region A to the exit pupil E. This causes a periodic brightness unevenness.

To avoid periodic brightness unevenness, the unit-mirrors of the multi-mirror 12a′ can be arranged at high density. For example, the unit-mirrors can be arranged to provide from about several periods through ten periods within a distance similar to the pupil diameter (about 6 mm) of the observing eye. In this configuration although a periodic brightness unevenness still is produced, no strange sensations therefrom are conveyed to the observing eye.

To further avoid periodic brightness unevenness, the ratio of (a) the reflectance RA of the region A of the second reflective-transmissive surface 12a-2 proximal to the first reflective-transmissive surface 12a-1 to (b) the reflectance RB of the region B located remotely from the first reflective-transmissive surface 12a-1 can be made RA:RB=1:2. In this case, some of the light flux L is transmitted through the region A and is incident on the region B, which reflects this flux. Thus, the periodic brightness unevenness is substantially nullified.

Desirably, the reflectance ratio need not be 1:2 exactly at all times, but rather can be adjusted according to the differences between optical paths of reflected light or the like. Thus, the brightness on the exit pupil E of the light flux L reflected by the region A and the brightness of the light flux L reflected by the region B are uniform. This effect can be further enhanced when combined with a high-density arrangement of the unit shapes of the multi-mirror 12a′.

To avoid stepwise unevenness of brightness, a distribution can be imparted to the deflection efficiency of the multi-mirror 12a′ to the light flux L from the display. Assuming that the deflection efficiency of the multi-mirror 12a′ is uniformly 25% and designating the incidence regions of the light flux L on the multi-mirror 12a as EA, EB, EC, . . . , in order of incidence, the brightness of the light flux L as incident on the exit pupil E from the respective regions is as follows:
EA: 25%
EB: 18.75%
EC: 14.0625%, . . .
   The resulting difference between the respective brightnesses causes the stepwise brightness unevenness.

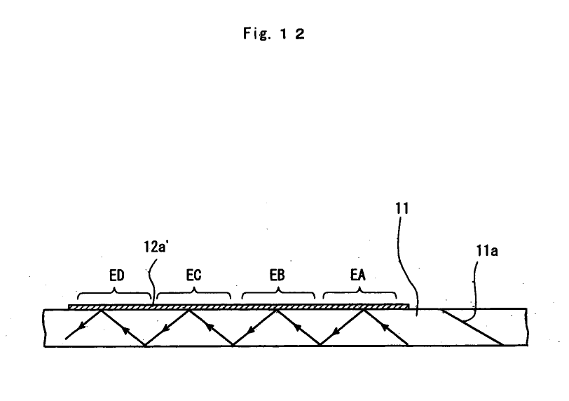

Whenever a distribution is provided to the deflection efficiency of the multi-mirror 12a′, as shown in FIG. 12, the deflection efficiencies of the respective incidence regions are as follows. If the number of times the light flux L is incident on the regions opposed to the exit pupil E in the multi-mirror 12a is four, then:
EA: 25%
EB: 33.3%
EC: 50%
ED: 100%
   By providing such a distribution, the brightness of the light flux L as incident on the exit pupil E can be made uniform to the 25% brightness of the light flux L at start of incidence. By setting the deflection efficiency of the final incidence region to 100%, the occurrence of stray light is prevented.

To provide a distribution to the deflection efficiency of the multi-mirror 12a′, a similar distribution may be provided to the reflectance of the second reflective-transmissive surface 12a-2. Alternatively, a similar distribution may be provided to the transmittance of the first reflective-transmissive surface 12a-1. However, whenever the distribution is provided to the deflection efficiency of the multi-mirror 12a, the transmittance of the multi-mirror 12a to external light flux incident on the observer side may be non-uniform. In such a case, one may have to allow some brightness unevenness of the exterior light flux as incident on the exit pupil E.

### Third Embodiment

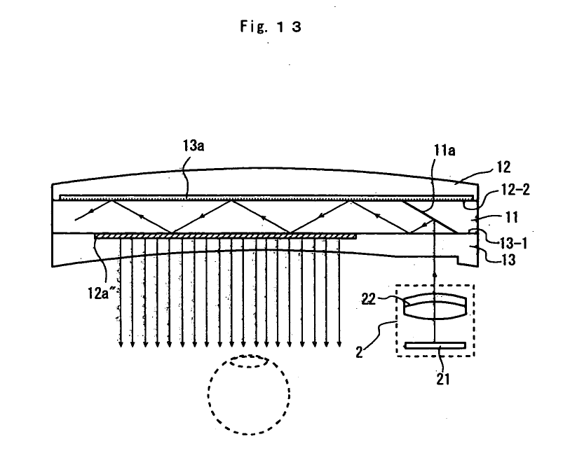

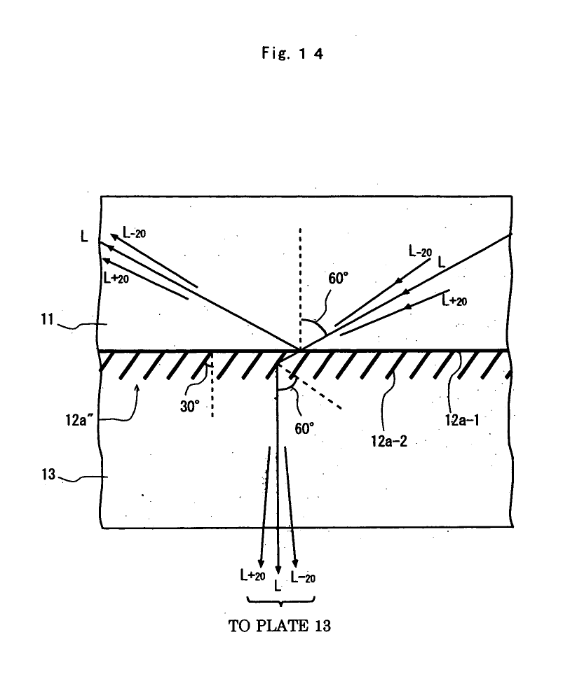

A third embodiment of the invention is described with reference to FIGS. 13-14 as follows. This embodiment is an eyeglass display. Here, only a point of difference from the second embodiment is described. The point of difference is that a multi-mirror 12a″ is provided in place of the multi-mirror 12a′. As shown in FIG. 13, a portion of the multi-mirror 12a″ is situated at the exterior-side surface 13-1 of the plate 13. Also, a portion of the reflective-transmissive surface 13a is disposed at the observer-side surface 12-2 of the plate 12.

As shown in FIG. 14, the multi-mirror 12a″ comprises a first reflective-transmissive surface 12a-1 and second reflective-transmissive surfaces 12a-2, similarly to the multi-mirror 12a′. However, the angle between the second reflective-transmissive surface 12a-2 and the normal line of the plate 13 is 30°. The second reflective-transmissive surface 12a-2 exhibits both reflection and transmission to light incident thereon at an angle in the vicinity of 60° (i.e., 40° to 80°).

When designing the angle characteristics of reflectance and transmittance of the first reflective-transmissive surface 12a-1, the second reflective-transmissive surfaces 12a-2 desirably are optimized in consideration of the number of times of internal reflection. This yields a balance (see-through clarity) of intensities of exterior light flux and light flux from the display that are incident on the exit pupil E or the like.

Operation of the multi-mirror 12a′ with regard to the light flux L propagating inside the plate 11 will be described. The following description representatively is directed to behavior of the light flux L (θᵢ=60°) at the center angular field of view, the light flux L₋₂₀ (θᵢ=40°) of the peripheral angular field of view, and the light flux L₊₂₀ (θᵢ=80°) of the peripheral angular field of view. As shown in FIG. 14, all of the light fluxes L, L₋₂₀, L₊₂₀ internally reflected by the plate 11 at angles of incidence in the vicinity of 60° (i.e., 40° to 80°) are not totally reflected at the boundary of the plate 11 with the first reflective-transmissive surface 12a-1. Rather, portions of the light flux are transmitted through the first reflective-transmissive surface 12a-1 to inside the plate 13. These transmitted light fluxes L, L₋₂₀, L₊₂₀ are respectively incident on the second reflective-transmissive surface 12a-2 at an angle of incidence in the vicinity of 60° (i.e., 40° to 80°), respectively. Portions of the light fluxes L, L₋₂₀, L₊₂₀ incident on the second reflective transmissive surface 12a-2 are reflected thereby through the plate 13 to outside the plate 13. That is, this eyeglass display achieves an effect similar to that of the eyeglass display of the second embodiment.

### Modified Third Embodiment

This embodiment concerns an exemplary change to the portion forming the multi-mirror in the eyeglass display of the second embodiment. As in the eyeglass display of the first embodiment, the portion that forms the multi-mirror can similarly be changed. In this case, the angle made by the second reflective-transmissive surface 12a-2 of the multi-mirror 12a relative to the normal line of the plate 13, and the angle made by the second reflective-transmissive surface 12a-2′ relative to the normal line of the plate 13 are respectively 30°.

### Other Embodiments

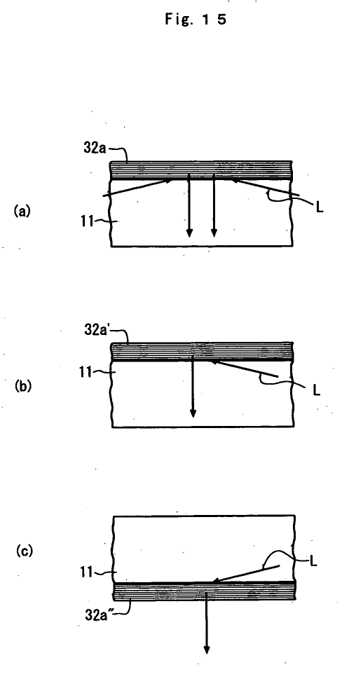

In place of the optical multilayer, portions of or all the first reflective-transmissive surface 12a-1 and the second reflective-transmissive surfaces 12a-2, 12a-2′ can comprise a metal film or an optical-diffraction surface (e.g., holographic surface or the like), or the like. As shown in FIG. 15(a), in place of the multi-mirror 12a in the first embodiment, an optical-diffraction surface (holographic surface or the like) 32a, which functions similarly to the multi-mirror 12a, is used. In FIG. 15(a), the light flux L from the display that is internally reflected inside the plate 11 and that is deflected by the optical-diffraction surface 32a is directed to the exit pupil E, as indicated by arrow marks. Whenever the optical-diffraction surface 32a is used, the light flux L directed to the exit pupil E is diffraction light produced by the optical diffraction surface 32a (which is desirably as an example of applying to an eyeglass display having a holographic surface).

Further, as shown FIG. 15(b), in place of the multi-mirror 12a′ used in the second embodiment, an optical-diffraction surface (e.g., holographic surface or the like) 32a′, which functions similarly to the multi-mirror 12a′, is used. In FIG. 15(b), the light flux L that is internally reflected inside the plate 11 and that is deflected by the optical-diffraction surface 32a′ is directed to the exit pupil E, as indicated by arrow marks. Whenever the optical-diffraction surface 32a′ is used, the light flux L from the display directed to the exit pupil E is diffraction light produced by the optical-diffraction surface 32a′.

As shown in FIG. 15(c), in place of the multi-mirror 12a″ used in the third embodiment, an optical-diffraction surface (e.g., a holographic surface or the like) 32a″, which functions similarly to the multi-mirror 12a′, is used. In FIG. 15(c), the light flux L that is internally reflected inside the plate 11 and that is deflected by the optical-diffraction surface 32a″ is directed to the exit pupil E, as indicated by arrow marks. Whenever the optical diffraction surface 32a″ is used, the light flux L from the display directed to the exit pupil E is diffraction light produced by the optical-diffraction surface 32a″. The optical-diffraction surfaces are, for example, surfaces of volume-type holographic elements or surfaces of phase-type holographic elements formed on a planar resin film or optical glass plate.

In fabricating the optical-diffraction surface, the angular dependence of diffraction efficiency thereof is optimized in consideration of the intended number of times of internal reflection, and in consideration of achieving a balance (see-through clarity) of respective intensities of exterior light flux and light flux from the display, as incident on the exit pupil E or the like.

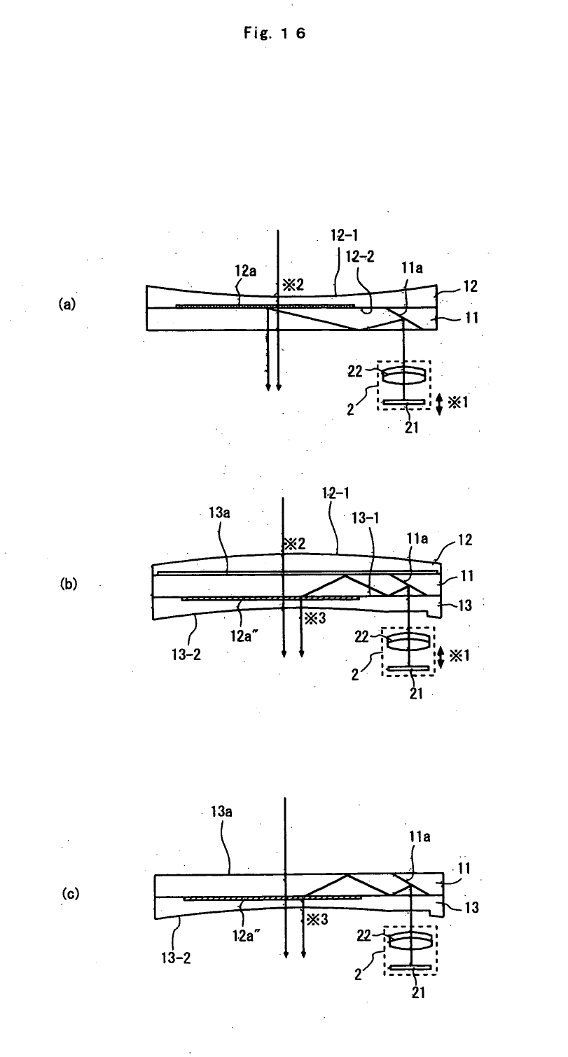

To achieve diopter correction of the eyeglass displays of the respective embodiments, other than the above-described method (refer to FIG. 8), for example, methods as shown in any of FIGS. 16(a), 16(b), and 16(c) or the like can be performed. The method of FIG. 16(a) can be used whenever the multi-mirror 12a is formed on the surface 12-2 on the observer side of the plate 12. The number of plates is restricted to two: the plate 12 and the plate 11. Thus, the reflective-transmissive surface 13a is omitted. In this method, diopter correction of the observing eye relative to the virtual image of the display screen is performed by optimizing the position, in the optical-axis direction, of the objective lens 22 (*1 in FIG. 16(a)). Diopter correction of the observing eye relative to the exterior image is performed by optimizing the curvature of the exterior-side surface 12-1 of the plate 12 (*2 in FIG. 16(a)). (Instead of changing the position of the object lens 22, the position of the liquid-crystal display 21 or the focal length of the objective lens 22 may be changed and optimized.)

The method shown in FIG. 16(b) can be applied whenever the multi-mirror 12a″ is formed at the exterior-side surface 13-1 of the plate 13. According to the method, diopter correction of the observing eye relative to the virtual image of the display screen is performed by optimizing a combination of the axial position of the objective lens 22 (*1 in FIG. 16(b)) and the curvature of the observer-side surface 13-2 of the plate 13. Diopter correction of the observing eye relative to the exterior image is performed by optimizing a combination of the curvature of the exterior-side surface 12-1 of the plate 12 (*2 in FIG. 16(b)) and the curvature of the observer-side surface 13-2 of the plate 13 (*3 in FIG. 16(b)). (Instead of changing the axial position of the objective lens 22, the axial position of the liquid-crystal display 21 or the focal length of the object lens 22 may be changed and optimized.)

The method shown in FIG. 16(c) can be applied whenever the multi-mirror 12a″ is formed at the exterior-side surface 13-1 of the plate 13. The number of plates is restricted only to two: plate 11 and plate 13. Thus, the reflective-transmissive surface 13a is omitted. According to the method, diopter correction of the observing eye relative to the virtual image of the display screen and diopter correction of the observing eye relative to the exterior image are performed by changing the curvature of the observer-side surface 13-2 of the plate 13 (*3 in FIG. 16(b)).

Although the reflective-transmissive surface 13a is used in a number of embodiments, in place of the reflective-transmissive surface 13a, an air gap may be provided at the same position. It is desirable to apply the reflective-transmissive surface 13a in view of a point at which the intensity of the optical-image display system 1 is increased.

As the eyeglass displays according to the various embodiments described above include two or three plates, any of the plates may comprise a pre-colored element, a photochromic element that is colored by ultraviolet rays, an electrochromic element colored by electrical conduction, or other element having a transmittance that can be changed. When such an element is used, the eyeglass display can be mounted with the intended function of weakening the brightness of an exterior light flux as incident on the observing eye, or weakening or blocking the influence of ultraviolet rays, infrared rays, or laser rays that are harmful to a naked eye (the function of sunglasses or laser-protective glasses).

In other embodiments the eyeglass display can be configured to provide a light-blocking mask (shutter) or the like for blocking and opening a light flux from the exterior. This would allow the observer to be immersed in the display screen as necessary or desired.

Although the eyeglass displays in the respective embodiments are configured to display the virtual image of the display screen only to one eye (right eye), the eyeglass displays can also be configured to display the virtual image to both the left and right eyes. Further, when stereoscopic images are displayed on left and right display screens, the eyeglass display can be used as a stereoscopic display.

Although the eyeglass displays in the respective embodiments are of the see-through type, the eyeglass displays may be of a non-see-through type. In this case, the transmittance of an optical-deflection member (multi-mirror, optical-diffraction surface, or the like) with regard to exterior light flux may be set to zero. In the case of the multi-mirror, the respective transmittances of the second reflective-transmissive surface 12a-2 and the second reflective-transmissive surface 1 2a-2′ may be set to zero.

In the eyeglass displays of the respective embodiments, the direction of polarization of the light flux L from the display may be limited to s-polarized light. To limit to s-polarized light, a polarized liquid-crystal display 21 may be used, or a phase plate may be installed frontward of the liquid-crystal display 21. The phase plate may be adjustable. Whenever the light flux L from the display is limited to s-polarized light, it is easy to provide the above-described characteristics to the respective optical surfaces of the eyeglass display. When an optical multilayer is used for the optical surface, a film configured as an optical multilayer can be made simply.

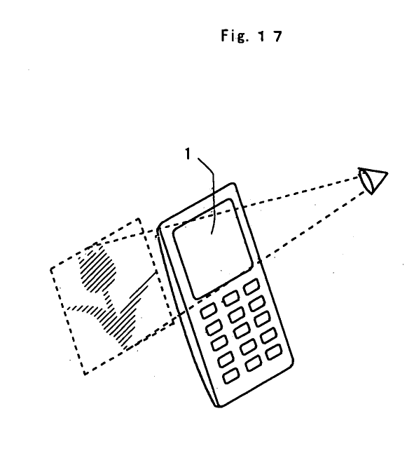

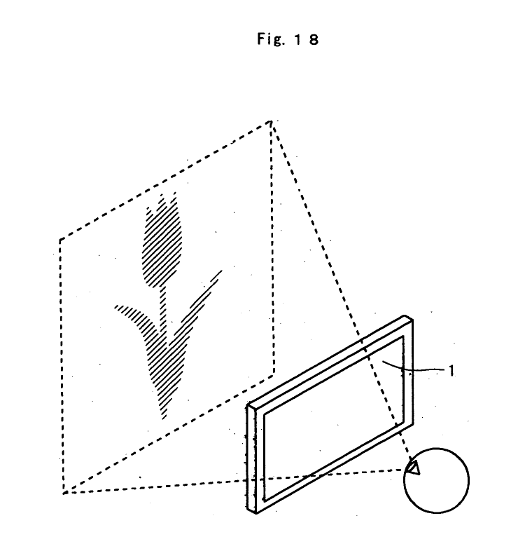

Although the respective embodiments concern eyeglass displays, an optical portion of the eyeglass display (optical-image display system, item 1 in FIG. 1, or the like) is applicable also to an optical apparatus other than an eyeglass display. For example, the optical-image system 1 may be applied to a display of a portable apparatus such as a portable telephone or the like, as shown in FIG. 17. As shown in FIG. 18, the optical-image display system 1 may be applied to a projector for displaying a virtual image by a large screen in front of the observer.

### Modified First Embodiment

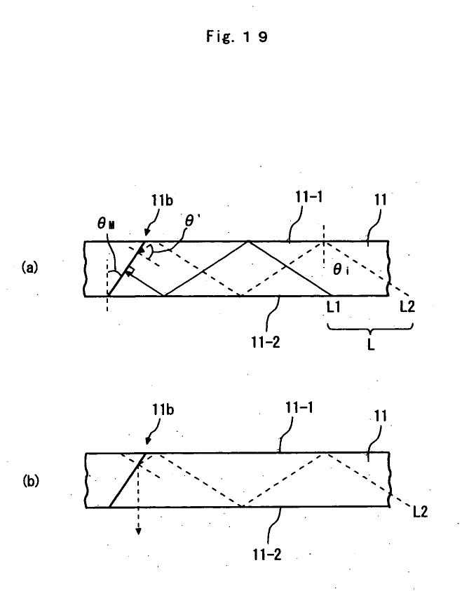

Descriptions are now provided of modified examples (first modified example, second modified example, third modified example, fourth modified example, fifth modified example, sixth modified example) of the first embodiment in reference to FIGS. 19-21, as follows. Here, only respective points of difference from the first embodiment are described, all of which pertaining to the return-reflective surface 11b.

FIGS. 19(a) and 19(b) depict operation of the return-reflective surface 11b of the first modified embodiment. Item L is the light flux from the display. Although the inclination of return-reflective surface 11a shown in FIG. 19 differs from the inclination of the return-reflective surface 11b of FIG. 3, the operations of both are similar. The direction of a normal line to the return-reflective surface 11b of the first embodiment coincides with the direction of propagation of the portion of the light flux L at the center angular field of view as internally reflected at the inside of the plate 11. Hence, the normal line returns the trajectory path of the portion of the light flux L of the peripheral angular field of view whenever the propagation direction of the flux is proximal to the normal line. In the following, the light flux L of the center angular field of view is described further.

The light flux L from the display is provided with a certain constant intensity, and the plate 11 is formed to be thin to some degree. Hence, the return-reflective surface 11b cannot return the trajectory path of all the light flux L incident thereon. In FIG. 19, the respective fluxes on the respective axes denoted L1 (slender bold line) and L2 (slender dotted line) represent respective light fluxes comprising the light flux L of the center angular field of view. In the example shown in FIG. 19, although the return-reflective surface 11b can return the trajectory path of the light flux denoted by the ray L1, the return-reflective surface 11b cannot return the trajectory path of the light flux denoted by the ray L2. This is because the ray L1 is vertically incident on the return-reflective surface 11b immediately after the ray has been reflected internally at the surface 11-2. On the other hand, the ray L2 is incident on the return-reflective surface 11b immediately after having been reflected internally at the surface 11-1, but this incidence of the ray L2 on the return-reflective surface 11b is not vertical.

As shown in FIG. 19(b), the ray L2 is reflected in a non-return direction by the return-reflective surface 11b and thus propagates to outside the plate 11. This emitted ray L2 can become stray light for the observing eye. The relationship between the angle of incidence θᵢ of the light flux L to the surface 11-1 or to the surface 11-2 of the plate 11 and the angle θ_{M} made by the return-reflective surface 11b and the normal line of the plate 11 is expressed in the following Equation (3):
θ_{M}=90°−θᵢ (3)
Hence, the angle of incidence θ′ of the ray L2 on the return-reflective surface 11b is expressed in the following Equation (4):
θ′=2θ_{M}=2(90°−θᵢ) (4)
For example, if θᵢ=60°, similar to the first embodiment, since θ_{M}=30°, θ′=60°.

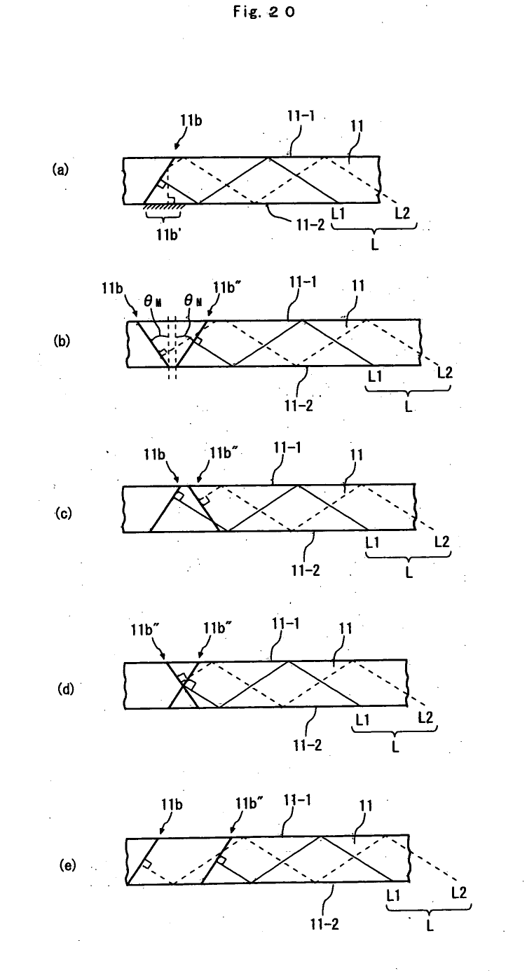

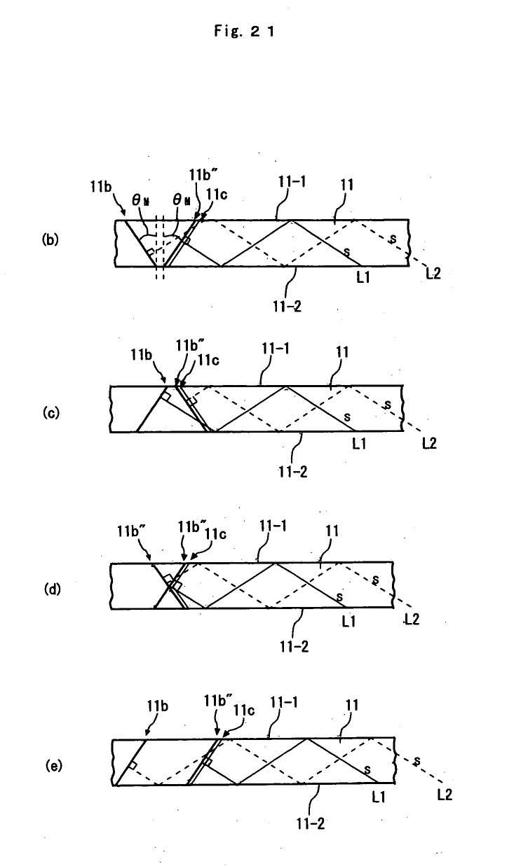

One return-reflective surface is added in order to eliminate the cause of stray light. FIGS. 20(a), 20(b), 20(c), 20(d), 20(e) show first to fifth modified examples, respectively, incorporating this feature. FIG. 21 illustrates a sixth modified example made by further modifying the second to fifth modified examples.

### FIRST MODIFIED EXAMPLE

The first modified example, shown in FIG. 20(a), comprises two return-reflective surfaces 11b, 11b′ arranged as shown. The direction of a normal line of the return-reflective surface 11b coincides with the direction of propagation of the ray L1. The angular dependence of reflectance exhibited by the return-reflective surface 11b reveals high reflectance over a wide range of angles extending at least from the vicinity of a vertical line (vicinity of 0°) to the vicinity of the angle θ′. Therefore, the return-reflective surface 11b returns the optical trajectory of the light flux denoted by the ray L1 and reflects the light flux denoted by the ray L2 in a non-return direction.

A portion of the return-reflective surface 11b′ is disposed in the optical path of the ray L2 reflected by the return-reflective surface 11b (i.e., the optical path of a light flux denoted by the ray L2). The direction of a normal line of the return-reflective surface 11b′ coincides with the direction of propagation of the ray L2. The angular dependence of reflectance exhibited by the return-reflective surface 11b′ reveals high reflectance at least in the vicinity of a vertical line (vicinity of 0°). Therefore, the return-reflective surface 11b′ returns the trajectory path of the light flux denoted by the ray L2.

In view of the above, according to this modified example, the trajectory of the light flux L from the display is returned more firmly than in the first embodiment, which reduces the cause of stray light. A generally reflective film of a metal such as silver, aluminum, or the like, or a dielectric multi-layered film or the like can be used to form the return-reflective surfaces 11b, 11b′ having the above-described characteristics. Alternatively or in addition, a holographic surface having a characteristic similar to that of the reflective film can be applied to the return-reflective surfaces 11b, 11b′.

Whenever θᵢ=60°, since the direction of the normal line of the return-reflective surface 11b′ coincides with the direction of the normal line of the plate 11, it is possible to provide a reflective film in a region of a portion of the surface 11-2 of the plate 11, and to use the reflective film as the return-reflective surface 11b′, as shown in FIG. 20(a). The area of the return-reflective surface 11b′ is sufficient whenever it is substantially the same as the area of a projected image on the surface 11-2 of the return-reflective surface 11b. It is desirable to limit the area to a necessary minimum to avoid deterioration of the see-through clarity of the eyeglass display.

### SECOND MODIFIED EXAMPLE

The second modified example is shown in FIG. 20(b), and comprises two return-reflective surfaces 11b″, 11b arranged as shown. The inclination of the return-reflective surface 11b″ is the same as of the return-reflective surface 11b of the first modified example. The angular dependence of reflectance and transmittance exhibited by the return-reflective surface 11b″ reveals a sufficiently high reflectance with respect to the ray L1 and with respect to the light flux of the peripheral angular field of view reflected by traveling a stroke similar to that of the ray L1. The angular dependence of reflectance and transmittance reveals a sufficiently high transmittance with regard to the other angle range, at least with respect to the ray L2 and the light flux of the peripheral angular field of view reflected by traveling a stroke similar to that of the ray L2 (at least in an angle by which at least light fluxes are incident on the return-reflective surface 11b″).

That is, the angle dependence of reflectance and transmittance of the return-reflective surface 11b″ shows a high reflectance in the vicinity of a vertical line (vicinity of θ°) and shows a high transmittance in the vicinity of the angle θ°. Hence, the return-reflective surface 11b″ returns the trajectory path of the light flux denoted by the ray L1 and transmits the light flux denoted by the ray L2.

The return-reflective surface 11b can be omitted in the optical path of the light flux transmitted through the return-reflective surface 11b″ (i.e., the light flux denoted by the ray L2). The direction of the normal line of the return-reflective surface 11b coincides with the direction of propagation of the ray L2. Note that, at this time, the direction of inclination of the return-reflective surface 11b and the direction of inclination of the return-reflective surface 11b″ are opposite each other, and angles thereof made by the normal line of the plate 11 respectively become θ_{M}. The angular dependence of reflectance of the return-reflective surface 11b is the same as that of the return-reflective surface 11b of the first modified example. Therefore, the return-reflective surface 11b returns the trajectory path of the light flux denoted by the ray L2. As a result, according to this modified example, an effect similar to that of the first modified example is achieved.

The return-reflective surface 11b″ having the above-described characteristic can be applied to a dielectric multilayered film or a holographic surface. It is desirable to make the interval between the return-reflective surface 11b″ and the return-reflective surface 11b as small as possible so as down-size the eyeglass display. Whenever the interval is increased, the variation in vertical-view angle (the view angle in a direction orthogonal to the paper face) by the position of the exit pupil in the left and right direction is increased. Hence, it is desirable to reduce the interval in order to minimize this variation.

### THIRD MODIFIED EXAMPLE

According to the third modified example, as shown in FIG. 20(c), the directions of inclination of the return-reflective surface 11b and of the return-reflective surface 11b″ of the second modified example are reversed. The respective angles of reflectance and transmittance exhibited by the return-reflective surface 11b″ reveal a sufficiently high reflectance to the ray L2 and to the light flux of the peripheral angular field of view reflected by traveling a stroke similar to that of the ray L2. The angle dependence reveals a sufficiently high transmittance with regard to other angle ranges, at least the ray L1 and the light flux of the peripheral angular field of view reflected by traveling the stroke similar to that of the ray L1 (at least in angles of the light fluxes incident on the return-reflective surface 11b″).

The configuration of the return-reflective surface 11b″ may be the same as that of the return-reflective surface 11b″ of the second modified example. This is because the relationship between the return-reflective surface 11b″ and the ray L2 of the third modified example is the same as the relationship between the return-reflective surface 11b″ and the ray L1 according to the second modified example (that is, an angle of incidence of θ°). Also, the angle between the ray of the center angular field of view and the ray of the peripheral angular field of view remains the same between the second modified example and the third modified example.

Therefore, the return-reflective surface 11b″ returns the trajectory path of the light flux denoted by the ray L2 and transmits the light flux denoted by the light flux L1. The return-reflective surface 11b returns the trajectory path of the light flux transmitted through the return-reflective surface 11b″ (light flux denoted by the ray L1). As a result, according to this modified example, an effect similar to those of the above-described respective modified examples is achieved.

It is desirable to make the interval between the return-reflective surface 11b and the return-reflective surface 11b″ as small as possible to down-size the eyeglass display. Incidentally, with an increased interval, the variation in the vertical-view angle (viewing angle in the direction orthogonal to the paper face) caused by the position in the left and right directions of the exit pupil is increased. Hence, it is desirable to reduce the interval to suppress this variation.

### FOURTH MODIFIED EXAMPLE

According to the fourth modified example, as shown by FIG. 20(d), two return-reflective surfaces 11b″, having respective directions of inclination that are opposite each other, intersect each other inside the plate 11. The angular dependence of reflectance and transmittance of the two return-reflective surfaces 11b″ is the same as exhibited by the return-reflective surfaces 11b″ in the respective modified examples described above. Consequently, the return-reflective surface 11b″ on one side returns the trajectory path of the light flux denoted by the ray L1 and transmits the light flux denoted by the light flux L2. The return-reflective surface 11b″ on other side returns the optical path of the light flux denoted by the ray L2 and transmits the light flux denoted by the light flux L1.

As described above, according to the modified example, an effect similar to those of the above-described modified examples is achieved.

It is not necessary that the point of intersection of the two return-reflective surfaces 11b″ be at the mid-point in the thickness direction of the plate 11.

### FIFTH MODIFIED EXAMPLE

In this modified example, the return-reflective surfaces 11b″, 11b are arranged as shown in FIG. 20(e). The inclination of the return-reflective surface 11b″ is the same as of the return-reflective surface 11b″ in the second modified example. The angular dependence reflectance and transmittance of the return-reflective surface 11b″ is the same as exhibited by the return-reflective surfaces 11b of the above-described respective modified examples. Hence, the return-reflective surface 11b″ returns the trajectory path of the light flux denoted by the ray L1 and transmits the light flux denoted by the ray L2.

A portion of the return-reflective surface 11b is situated in the optical path of the light flux (denoted by the ray L2) that has been reflected internally an odd number of times (preferably, one time) after transmitting through the return-reflective surface 11b″. The direction of the normal line of the return-reflective surface 11b coincides with the direction of propagation of the ray L2. At this time, the inclination of the return-reflective surface 11b is the same as the inclination of the return-reflective surface 11b″.

The angular dependence of reflectance of the return-reflective surface 11b is the same as of the return-reflective surfaces 11b of the above-described respective modified examples. Consequently, the return-reflective surface 11b returns the trajectory path of the light flux denoted by the ray L2.

Therefore, this modified example achieves an effect similar to the other modified examples described earlier above.

### SUPPLEMENT OF MODIFIED EXAMPLE

Although the positions in the left and right direction of the respective return-reflective surfaces of the respective modified examples described above are basically arbitrary, it is desirable to select an optimum position that takes into consideration certain factors of machining and assembly. When the wavelength of the light flux L from the display is limited to a specific wavelength component (i.e., whenever the light source for the liquid-crystal display 21 has a narrow-band spectrum, such as an LED or the like), the return-reflective surface 11b″ need only exhibit reflectance for the specific wavelength component. Whenever the wavelength component of the light flux L from the display is limited in this way, the degrees of freedom with which the reflective film used in the return-reflective surface 11b″ can be configured are increased.

Whenever the light flux L from the display is limited to a specific polarized-light component (i.e., whenever the light source for the liquid-crystal display 21 is limited to a specific polarized-light component), the return-reflective surface 11b″ need only exhibit reflectance for the specific polarized-light component. When the polarized-light component of the light flux L from the display is limited in this way, the degrees of freedom with which the reflective film used in the return-reflective surface 11b″ are increased. If the polarized-light component of the light flux L is limited to s-polarized light, it is desirable that the second to fifth modified examples be further modified according to the sixth modified example, described below.

### SIXTH MODIFIED EXAMPLE

According to the sixth modified example, as shown by FIGS. 21(a), 21(b), 21(c), and 21(d), a λ/2 plate 11c is situated at the surface of the return-reflective surface 11b″ on which the light flux L from the display is first incident. The λ/2 plate 11c is shifted more or less to facilitate an understanding of forming the λ/2 plate 11c. With the λ/2 plate 11c, all directions of polarization of the light fluxes incident on the return-reflective surface 11b″ become those of p-polarized light. The angles of reflectance and of transmittance of the return-reflective surface 11b″ are established so that the return-reflective surface 11b″ transmits a light flux of p-polarized light incident at an angle in the vicinity of the angle θ′ and reflects a light flux incident at an angle in the vicinity of a vertical line (vicinity of θ°).

The degrees of freedom with which the reflective film, used as the return-reflective surface 11b″, can be high. Consequently, with a modified example using the λ/2 plate 11c, the degrees of freedom are increased.

### EXAMPLE 1

This example utilizes a reflective-transmissive surface 13a including an optical multilayer. The reflective-transmissive surface 13a is used when the light flux L from the display is limited to s-polarized light. The configuration of the reflective-transmissive surface 13a is as follows, in which constituent layers of each unit are within parentheses:
plate/(0.3L 0.27H 0.14L)^{k1}·(0.155L 0.27H 0.155L)^{k2}·(0.14L 0.27H 0.3L)^{k3}/plate
The refractive index of the plate is 1.74. The notation “H” denotes a high-refractive index layer (refractive index=2.20), the notation “L” denotes a low-refractive index layer (refractive index 1.48), the superscripts k1, k2, k3 denote the respective numbers of times the respective layers were laminated (which are 1 here), and the numeral preceding each layer denotes the optical-film thickness (nd/λ) of the respective layer for light having a wavelength of 780 nm.

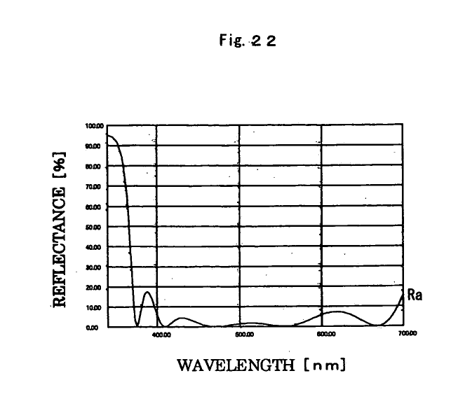

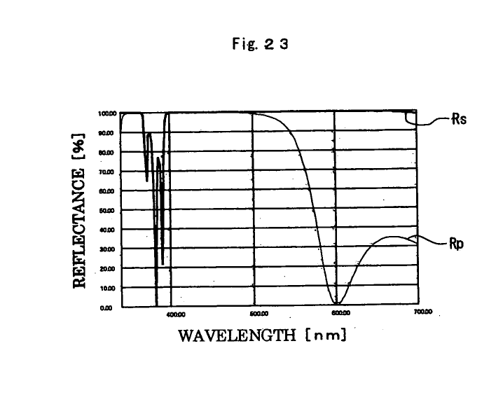

Reflectance versus wavelength of the reflective-transmissive surface 13a is as shown in FIGS. 22 and 23. FIG. 22 shows reflectance versus wavelength for vertically incident light (angle of incidence 0°), and FIG. 23 shows reflectance versus wavelength for light incident at 60° (angle of incidence 60°). In FIGS. 22 and 23 the notation Rs designates reflectance of s-polarized light, the notation Rp designates reflectance of p-polarized light, and the notation Ra designates the average reflectance for both s-polarized light and p-polarized light. In FIG. 22, with vertically incident light, the reflectance is limited to several percent, on average, within the visible-light region (400 through 700 nm). In FIG. 23, with s-polarized light incident at 60°, the reflectance is about 100% within the visible-light region (400 through 700 nm).

The reflective-transmissive surface 13a is configured as follows:
plate/(matching layers I)^{k1}·(reflective layers)^{k2}·(matching layers)^{k3}/plate
The respective layers are made of laminated low-refractive-index layers L, high-refractive-index layers H, and low-refractive-index layers L. The layers are configured so as to increase reflectance of light incident at 60°. Reflective layers configured as center layers tend to produce reflection of vertically incident light. Thus, film thicknesses of the respective layers of matching layers I, II are optimized for restraining reflection.

In designing the layers, the numbers of times of lamination k1, k2, k3 of the respective layers may be increased or reduced. Alternatively, the film thicknesses of the respective layers of the matching layers I, II may be adjusted in accordance with the angle of incidence of light, the refractive index of the plate, or the like.

Whenever the relationship between one plate and the reflective-transmissive surface 13a and the relationship between the other plate and the reflective-transmissive surface 13a differ from each other (such as when the refractive indices of two plates differ from each other, or an adhesive layer is interposed between one plate and the reflective-transmissive surface 13a, or the like), the numbers of times of lamination of the matching layers I, II and the film thicknesses of the respective layers may individually be adjusted.

Although the reflective-transmissive surface 13a of this example exhibits a certain performance with respect to s-polarized light, whenever similar performance is intended for both s-polarized light and p-polarized light, the reflective-transmissive surface 13a may be modified as follows. As shown in FIG. 23, the reflective-transmissive surface 13a of this example exhibits a reflection for p-polarized light only for a portion of the visible-light region. Hence, the configuration may be connected with one or a plurality of layers having a center wavelength (a wavelength that maximizes reflectance) that deviates from that of the above-described respective layers. Hence, the reflectance is achievable over the entire visible-light region for both s-polarized light and p-polarized light.

### EXAMPLE 2

In this example the first reflective-transmissive surface 12a-1 includes an optical multilayer. The first reflective-transmissive surface 12a-1 is applicable whenever the light flux L from the display is limited to s-polarized light. The basic configuration of the first reflective-transmissive surface 12a-1 is as follows:
plate/(0.5L 0.5H)^{k1}·A(0.5L 0.5H)^{k2}/plate

The refractive index of the plate is 1.54. The notation H in respective layers designates a high-refractive-index layer (refractive index 1.68), the notation L designates a low-refractive-index layer (refractive index 1.48), the superscripts k1, k2 designate numbers of times of lamination of the respective layers, the numeral preceding each layer designates the optical-film thickness (nd/λ) for light having a wavelength of 430 nm, and the factor “A” preceding the second layers designates a correction coefficient for correcting a film thickness of the second layers. In this configuration, both the first layers and the second layers have an optical-film thickness of 0.5λ for a particular wavelength inside or outside the range of visible light. Also, a layer having such a film thickness exhibits reflectance behavior that is substantially the same as in a case in which the film is not present at a center wavelength. The refractive indices of both of the high-refractive-index layers H and the low-refractive-index layers L are not much different from the refractive index of the plate, and Fresnel reflection (at the interfaces of layers and of vertically incident light) is also low. Therefore, vertically incident light is hardly reflected.

Optical admittances of the plate and the respective layers, for angles of incidence θ are expressed by ncos θ for p-polarized light and n/cos θ for s-polarized light, where n is the refractive index. That is, the ratio of admittances between materials is increased in accordance with an increase in angle of incidence θ for s-polarized light. Consequently, Fresnel reflection at the interfaces is increased with corresponding increases in the angle of incidence θ, which produces increased reflectance. The above-described basic configuration is set by the above-described principle.

In order to set the wavelength dependence of reflectance of the first reflective-transmissive surface 12a-1 to a desired value, respective parameters (here, k1, A, k2) for the basic configuration may be adjusted in a suitable manner.

### EXAMPLE 2′

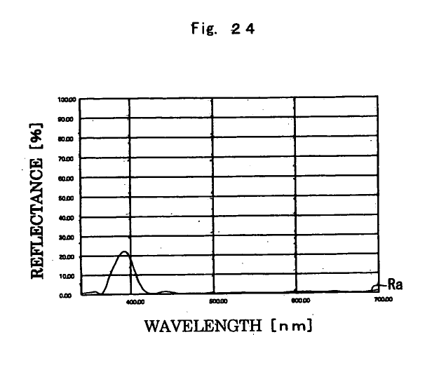

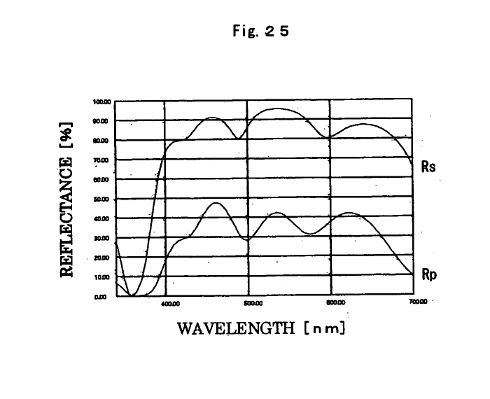

In this example, to achieve an average transmittance of about 15% over the entire visible spectrum and relative to light incident at 60°, the parameters may be k1=4, A=1.36, and K2=4. The configuration of the first reflective-transmissive surface 12a-1 in this case is expressed as follows:
plate/(0.5L 0.5H)⁴·1.36(0.5L 0.5H)⁴/plate
The relationship of reflectance to wavelength of the first reflective-transmissive surface 12a-1 is as shown in FIG. 24 and FIG. 25. FIG. 24 shows reflectance of vertically incident light, and FIG. 25 shows reflectance of light incident at 60°. In FIGS. 24 and 25, Rs denotes reflectance of s-polarized light, Rp denotes reflectance of p-polarized light, and Ra denotes an average reflectance for s-polarized light and p-polarized light.

As shown in FIG. 24, reflectance is reduced to about 0% over the entire visible-light region (400 through 700 nm) for vertically incident light. In FIG. 25 the 85% reflectivity on average (i.e., 15% transmittance) is achieved over the entire visible-light region (400 through 700 nm) for s-polarized light at 60° incidence.

### Second Embodiment—2

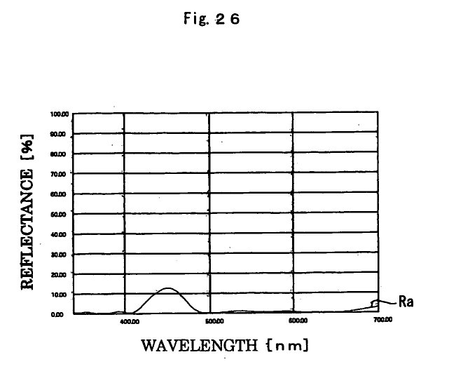

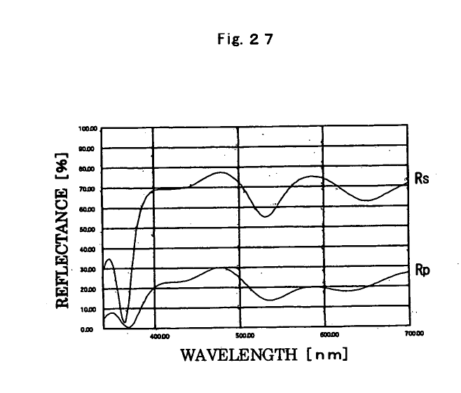

To achieve a transmittance of about 30% on average over the entire visible-light region for light incident at 60°, the parameters may be set as: K1=3, K2=3, A=1.56. The configuration of the first reflective-transmissive surface 12a-1 is expressed as follows:
plate/(0.5L 0.5H)³·1.56(0.5L 0.5H)³/plate
The wavelength dependence of reflectance of the first reflective-transmissive surface 12a-1 is shown in FIG. 26 and FIG. 27. FIG. 26 depicts the wavelength dependence of reflection of vertically incident light, and FIG. 25 depicts the wavelength dependence of light incident at 60°. In the figures Rs denotes reflectance of s-polarized light, Rp denotes reflectance of p-polarized light, and Ra denotes an average reflectance for s-polarized light and p-polarized light. In FIG. 26, reflectance is limited to about 0% over the entire visible-light region (400 through 700 nm) for vertically incident light. In FIG. 27 the reflectance, over the entire visible-light region (400 through 700 nm), is 70% (i.e., transmittance is 30%) on average for s-polarized incident at an angle of 60°.

### EXAMPLE 3

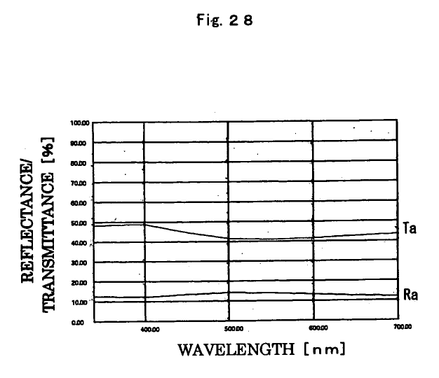

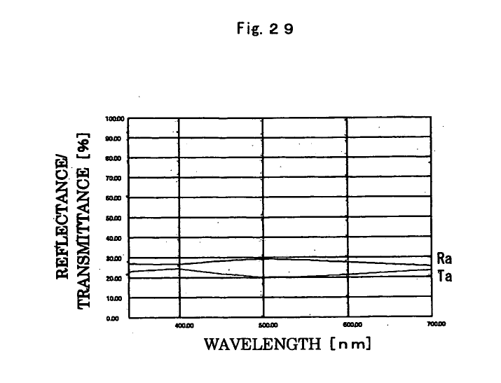

In this example the second reflective-transmissive surfaces 12a-2, 12a-2′ are composed of metal films. The metal films advantageously are easily fabricated and are inexpensive. In this example Cr (chromium) is used for the second reflective-transmissive surfaces 12a-2, 12-2′. The wavelength dependence of reflectance/transmittance of light incident at 30° on the second reflective-transmissive surfaces 12a-2, 12a-2′ is shown in FIG. 28 and FIG. 29. FIG. 28 presents data obtained with a Cr film thickness of 10 nm, and FIG. 29 presents data obtained with a Cr film thickness of 20 nm. In both figures, Ra denotes reflectance, and Ta denotes transmittance.

In FIG. 28, when the film thickness is 10 nm, a transmittance of only 40% or more on average is achieved over the visible-light region. Reflectance is only 10% or more on average. Here, four tenths of the light flux from exterior can reach the exit pupil E, and only one tenth of the light flux L from the display can reach the exit pupil E. The remaining light is absorbed.

In FIG. 29, when the film thickness is 20 nm, although reflectance and transmittance are substantially equal, only 20% or more of the incident light can be utilized. Thus, whereas the metal film achieves the above-described advantages, loss of light by absorption is large, which reduces the amount of light in the light flux L from the display. This leads to a deterioration of see-through clarity.

### EXAMPLE 4

In this example the second reflective-transmissive surfaces 12a-2, 12a-2′ include an optical multilayer (3-band mirror or polarization beam-splitter type mirror, as mentioned later). The second reflective-transmissive surfaces 12a-2, 12a-2′ are configured with consideration given to the fact that the liquid-crystal display 21 has an emission spectrum.

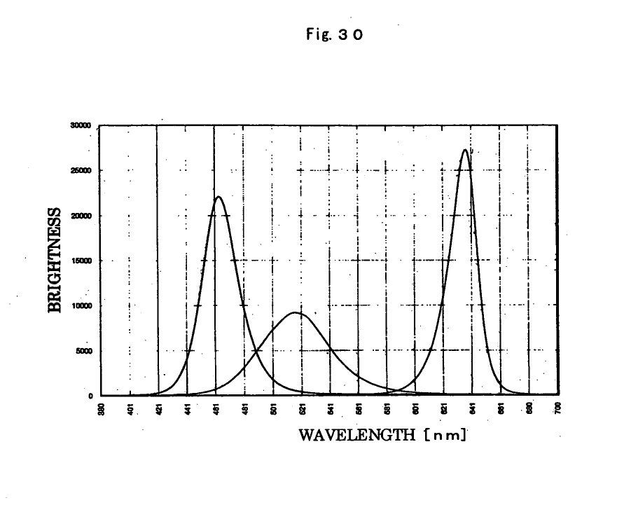

FIG. 30 shows a distribution of emission spectrum (wavelength dependence of emission brightness) of the liquid-crystal display 21. As ascertained from the figure, the distribution includes peaks at respective vicinities of substantially 640 nm (R color), 520 nm (G color), 460 nm (B color).

Desirably, the second reflective-transmissive surfaces 12a-2, 12a-2′ have high reflectance mainly at the wavelength regions. It is also desirable also to take into consideration polarized light, if possible. In this example the second reflective-transmissive surfaces 12a-2, 12-2′ include a 3-band mirror or a polarization beam-splitter type mirror. The 3-band mirror reflects only light at narrow-wavelength regions, in the vicinities of peaks of the emission spectrum. The polarization beam-splitter type mirror reflects only light of the narrow wavelength regions in the vicinities of peaks of the emission spectrum and limits an object of reflection only to the s-polarized light component.

The second reflective-transmissive surfaces 12a-2, 12a-2′, including the 3-band mirrors, reflect only light of the limited-wavelength regions. Hence, loss of light flux L from the display is restrained, and screen brightness is maintained. Although the second reflective-transmissive surfaces 12a-2, 12a-2′ cannot transmit light of the limited-wavelength regions of light flux from the exterior, light of almost any other wavelength region is transmitted thereby. Hence, loss of light flux from the exterior is reduced, and see-through clarity is promoted.

The second reflective-transmissive surfaces 12a-2, 12a-2′, including the polarization beam-splitter type mirrors, further reflect only the s-polarized light component of the limited-wavelength region. So far as the light flux L from the display is limited to s-polarized light, loss of light flux L from the display is further reduced, and the brightness of the display screen is further facilitated. Only the s-polarized light component of the limited-wavelength region of the light flux from the exterior cannot transmit through the second reflective-transmissive surfaces 12a-2, 12a-2′. Hence, loss of light flux from the exterior is further reduced, and see-through clarity is further promoted.

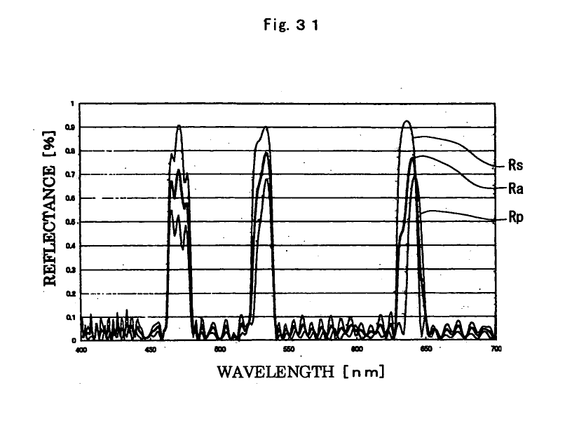

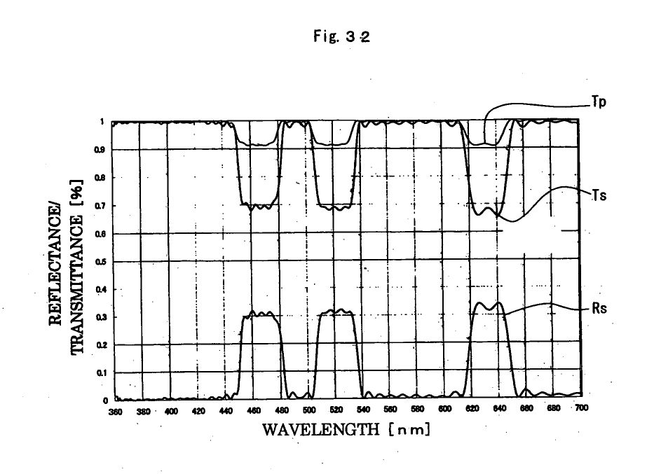

The wavelength dependence of reflectance (transmittance) of the 3-band mirror, to light incident at 30°, is shown in FIG. 31, and the wavelength dependence of reflectance (transmittance) of the polarization beam-splitter type mirror for light incident at 30° is shown in FIG. 32. In both figures Rs denotes reflectance for s-polarized light, Rp denotes reflectance for p-polarized light, Ra denotes average reflectance for both s-polarized light and p-polarized light, Ts denotes transmittance of s-polarized light, and Tp denotes transmittance for p-polarized light. In FIG. 31 with the 3-band mirror, a reflectance of about 70% is achieved for light in wavelength regions corresponding to R (red) color, G (green) color, and B (blue) color. FIG. 31 shows data for R color, G color, and B color on a multilayered film (referred to as a “minus” filter), which reflects only light of the specific wavelength regions and transmits other light. The figure shows data when the film is laminated on a computer and the total layer configuration is optimally designed. In FIG. 32, with the polarization beam-splitter type mirror, the width of the wavelength region is enlarged rather than increasing the height of peak reflectance. Thus, the amount of light, of a total of the light flux L from the display, is ensured. With an increase in reflectance of s-polarized light by an angle of incidence of 30°, the reflectance of p-polarized light is increased. At a larger angle of incidence, the transmittance of p-polarized light can be ensured while achieving substantially 100% reflectance of s-polarized light. Therefore, with the use of the polarization beam-splitter type mirror to the multi-mirror as a second reflective-transmissive surface, a very effective deflection behavior achieved, depending on the structure of the multi-mirror.

FIG. 32 shows data for R color, G color, and B color on the polarization beam-splitter type mirror that reflects only s-polarized light of the specific wavelength region and transmits other light. The figure shows data for when the film is laminated on a computer and the total layer configuration is optimally designed.

### EXAMPLE 5

This example concerns a method for forming respective holographic surfaces used in the respective embodiments. Basically, a holographic photosensitive material is prepared. Reference light and light from an object are made incident on the holographic photosensitive material from a vertical direction and from an angle θ. Multiple exposures are carried out by the three wavelengths of R color, G color, and B color. The angle θ is equal to the angle of incidence of light to be reflected at a high diffraction efficiency. The holographic photosensitive material is developed and bleached. Whenever the holographic photosensitive material produced in this way is adhered to a desired surface, the surface can be utilized as a holographic surface.

By preparing a holographic surface that functions in the same manner as the multi-mirror 12a (refer to FIG. 6) having two second reflective-transmissive surfaces 12a-2, 12a-2′, multiple exposure can be made twice by setting the above-described angle not only to θ but also to −θ. Also, generally, since the holographic photosensitive material is made of a resin film, it is easy to bond the holographic material onto a desired plate or to integrate the bonded plate to another plate.

### EXAMPLE 6

In this example the return-reflective surface 11b″ is applied to the sixth modified example (refer to FIG. 21), and the light flux L from the display is limited to s-polarized light. The angle of incidence is set to θ′=60°. Here, θ′ denotes the angle of incidence of the ray L2 on the return-reflective surface 11b (refer to FIG. 19(a)).

The basic configuration of the return-reflective surface 11b″ is expressed by any of the following three types:
(1) plate/(0.25H 0.25L)^{k}0.25H/plate
(2) plate/(0.125H 0.25L 0.125H)^{k}/plate
(3) plate/(0.125L 0.25H 0.125L)^{k}/plate

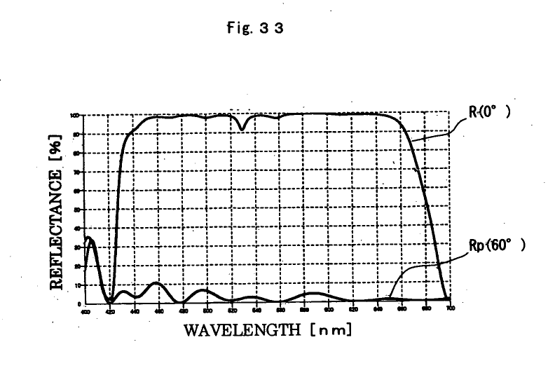

Hence, this example adopts the first type (1), in which a basic constitution is set using two of periodic-layer blocks to extend a reflection band. The following constitution of 40 layers is obtained through trial and error:
plate/(0.25H 0.25L)¹⁰ 0.1L(0.3125H 0.3125L)¹⁰/plate
The refractive index of the plate is set to 1.56, the refractive index of the high-refractive index layer H is set to 2.20, and the refractive index of the low-refractive index layer L is set to 1.46. The angle-versus-wavelength behavior of reflectance exhibited by the return-reflective surface 11b″ is shown in FIG. 33, in which R(0°) denotes the wavelength characteristic of reflectance of vertically incident light. Note that the reflectance becomes substantially 100% in the visible-light region. Rp(60°) denotes the wavelength characteristic of reflectance of p-polarized light that is incident at 60°. Note that the reflectance becomes substantially 0% in the visible-light region. i.e., the transmittance for p-polarized light incident at 60° becomes substantially 100% in the visible-light region. In the subsequent figures, a similar description applies.

### EXAMPLE 6′

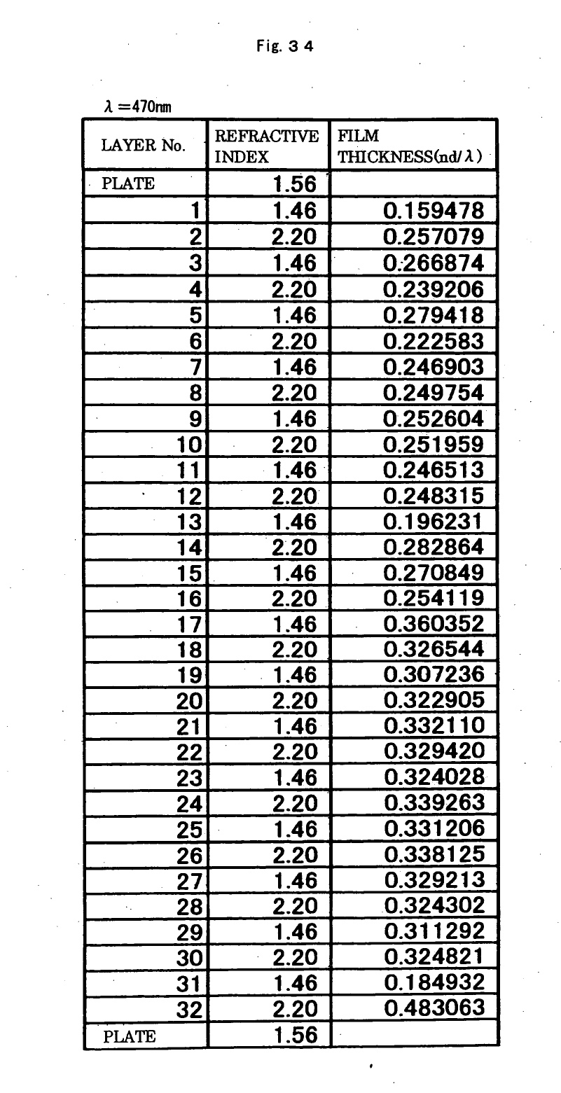

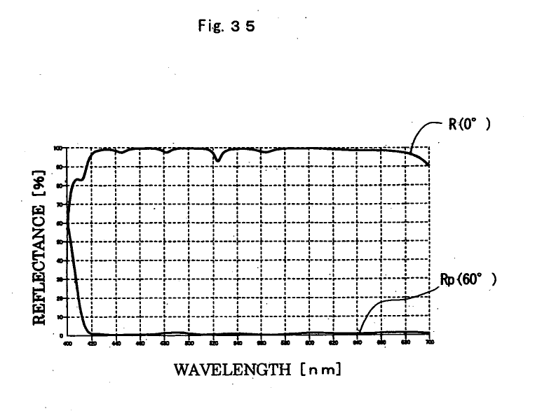

In this example optimization design is carried out using a computer, investigating a reduction in the number of layers and seeking improvements in performance. A configuration of a multilayered film having a particular angle/wavelength characteristic produced the reflectance/transmittance behavior shown in FIGS. 34 and 35. As is apparent from these figures the number of layers can be reduced by optimization design. Also, reflectance for vertically incident light can be brought closer to 100%, and transmittance for incident p-polarized light can be brought closer to 100%.

### EXAMPLE 7

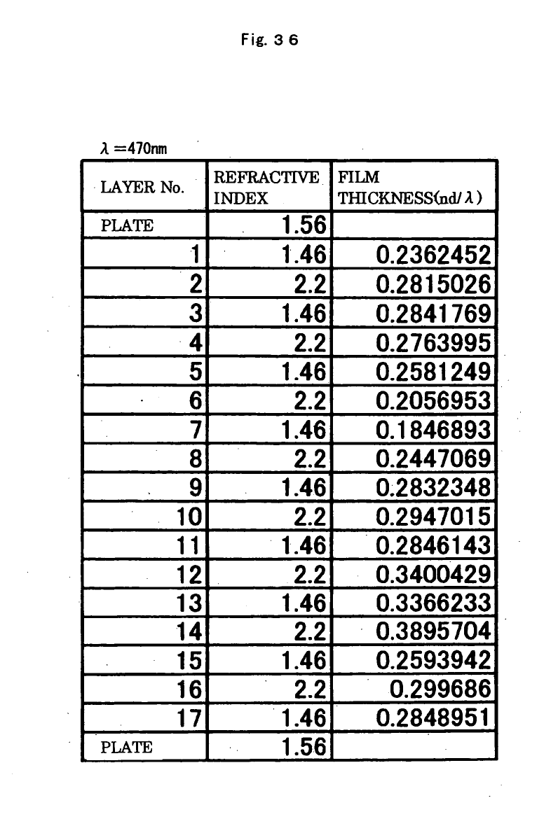

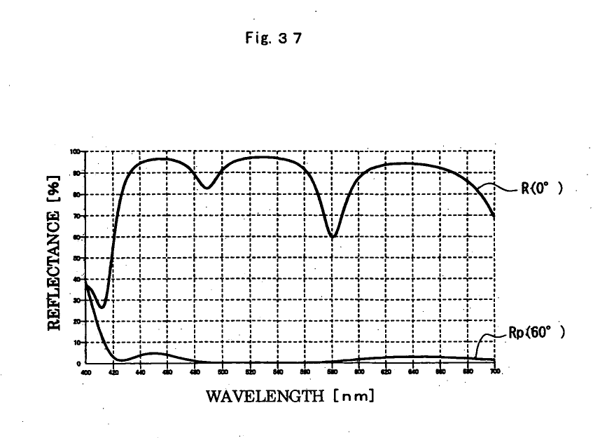

In this example the return-reflective surface 11b″ of the sixth modified example is investigated (refer to FIG. 21, in which the light flux L from the display is limited to s-polarized light). Here, θ′=60°, and the return-reflective surface 11b″ of the embodiment takes into consideration the fact that the liquid-crystal display 21 is provided with the emission spectrum (see FIG. 30). As in Example 6, optimalization design is carried out using a computer. With the particular configuration of multilayered film, the angle/wavelength characteristic of reflectance/transmittance is as shown in FIG. 36 and FIG. 37. As apparent in FIG. 36, the number of layers is further reduced. As apparent in FIG. 37, the reflectance of the specific wavelength component (R color, G color, B color) in vertically incident light is high and reflectance of the other unnecessary wavelength components is reduced. By increasing only the reflectance of the necessary wavelength component, the number of layers can be reduced.

### EXAMPLE 8

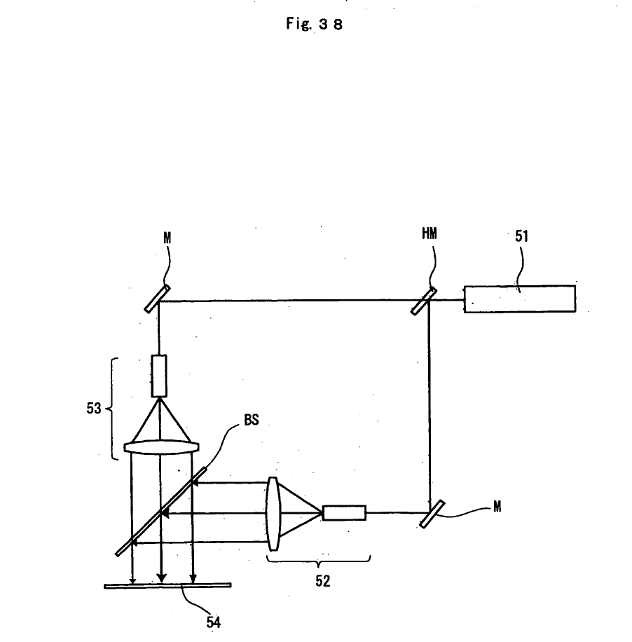

This example pertains to forming a holographic surface used for the return-reflective surfaces 11b, 11b′, 11b″ shown in FIG. 20 and FIG. 21. The principle is the same as described in Example 5, and is characterized only in angles of incidence of light for reference and light from an object on the holographic photosensitive material. An explanation is given with reference to FIG. 38, which laser light emitted from a light source 51 is divided into two beams of laser light by a half-mirror HM. The diameters of the two branches of laser light are respectively enlarged by beam expanders 52, 53 by way of mirrors M. The two beams of laser light are used as light from the object and a reference light.

The light from object and the reference light are made to be vertically incident on the holographic photosensitive material 54 after having been superposed by a beam-splitter BS. Thus, the holographic photosensitive material 54 is exposed. When the light from the object and the reference light are made to be vertically incident on the holographic photosensitive material 54 in this way, a holographic surface is formed for achieving high reflectance of vertically incident light flux L from the display (refer to FIG. 20 and FIG. 21).

The invention is not limited to the above embodiments and various modifications may be made without departing from the spirit and scope of the invention. Any improvement may be made in part or all of the components.

1.-19. (canceled)

20. An optical-image display system, comprising:
a light-transmissive plate defining an interior space configured to provide a forward trajectory path for a light flux from a display device, the light flux comprising respective individual light fluxes produced at each of multiple angular fields of view of an image-display element of the display device, the trajectory path being configured and directed to internally reflect the light flux multiple times as the light flux propagates in the interior space; and
an optical-deflection member disposed relative to a predetermined region of a surface of the plate and configured to deflect, by reflection, at least a respective first portion of each individual light flux, that has reached the predetermined region, in a predetermined direction and thus to emit to outside the plate the respective portions of each individual light flux in a manner that forms a virtual image of the image-display element.

21. The optical-image display system of claim 20, wherein:
the optical-deflection member is further configured to emit the respective portions of the individual light fluxes to an exit pupil of the system; and
the optical-deflection member is further configured to have a deflection characteristic distributed so as to produce a substantially uniform brightness of the light flux incident on the exit pupil.

22. The optical-image display system of claim 20, further comprising a return-reflective surface situated and configured to reflect the light flux, propagating forwardly along the trajectory path in the light-transmissive plate, rearwardly in a manner that returns the trajectory path in the interior space with continued internal reflection of the light flux and thus reciprocates propagation of the light flux in the interior space, wherein the deflection-optical member is further configured to deflect, in the predetermined direction, respective second portions of the individual light fluxes propagating rearwardly in the interior space.

23. The optical-image display system of claim 22, wherein the return-reflective surface comprises:
a first reflective surface situated and configured to return the trajectory path of the light flux passing through the predetermined region in the interior space within a first angle range; and
a second reflective surface situated and configured to return the trajectory path of the light flux passing through the predetermined region in the interior space within a second angle range that is different from the first angle range.

24. The optical-image display system of claim 23, wherein:
the first reflective surface is configured to reflect, in a non-return direction, the light flux passing within the second angle range; and
the second reflective surface is configured to return, in the non-return direction, the trajectory path of the light flux reflected by the first reflective surface.

25. The optical-image display system of claim 23, wherein:
the first reflective surface is configured to transmit the light flux passing within the second angle range; and
the second reflective surface is configured to return the trajectory path of the light flux transmitting through the first reflective surface.

26. The optical-image display system of claim 23, wherein:
the first reflective surface and the second reflective surface are arranged at a same position in the interior space so as to intersect each other;
the first reflective surface is configured to transmit the light flux from the display passing within the second angle range; and
the second reflective surface is configured to transmit the light flux from the display passing within the first angle range.

27. The optical-image display system of claim 22, wherein the optical-deflection member comprises:
a first optical surface situated proximally to the predetermined region and configured to transmit, to outside the plate, a respective portion of each of the individual light fluxes that have reached the predetermined region; and
a multi-mirror situated on a side of the first optical surface opposite the plate and comprising multiple micro-reflective surfaces arranged in at least one row and inclined to a normal line of the plate.

28. The optical-image display system of claim 27, wherein the micro-reflective surfaces collectively comprise an element selected from the group consisting of an optical multilayer and an optical-diffraction surface.

29. The optical-image display system of claim 22, wherein the optical-deflection member comprises an optical-diffraction member.

30. The optical-image display system of claim 22, wherein the optical-deflection member is further configured to transmit at least a portion of an external light flux, propagating from outside the plate to inside the plate, toward the exit pupil.

31. The optical-image display system of claim 22, further comprising a diopter-correcting element situated and configured to change a diopter characteristic of an observing eye situated at the exit pupil.

32. The optical-image display system of claim 20, wherein the optical-deflection member comprises:
a first optical surface proximally to the predetermined region and configured to transmit, to outside the plate, at least a respective portion of each of the individual light fluxes that have reached the predetermined region; and
a multi-mirror situated on a side of the first optical surface opposite to the plate and comprising multiple micro-reflective surfaces arranged in at least one row and inclined relative to a normal line of the plate.

33. The optical-image display system of claim 20, wherein the optical-deflection member comprises an optical-diffraction member.

34. The optical-image display system of claim 20, wherein:
the optical-deflection member is configured to deflect at least the respective first portions of the individual light fluxes in the predetermined direction toward an exit pupil of the system; and
the optical-deflection member is further configured to transmit at least a portion of an exterior light flux entering the plate and propagating toward the exit pupil.

35. The optical-image display system of claim 34, wherein the optical-deflection member is further configured to limit the deflection to light having a wavelength substantially equal to a wavelength of the light flux from the display.

36. The optical-image display system of claim 20, wherein the optical-deflection member is configured to deflect at least the respective first portions of the individual light fluxes in the predetermined direction toward an exit pupil of the system, the system further comprising a diopter-correcting element situated and configured to change a diopter characteristic of an observing eye situated at the exit pupil.

37. The optical-image display system of claim 36, further comprising a second plate mounted to the optically transmissive plate in a manner by which the optical-deflection member is interposed between the plate, wherein the diopter-correcting element comprises a curved face of the second plate that is situated on an opposite side of the second plate from the optical-deflection member, the curved face being configured to perform at least a portion of a diopter correction performed by the system.

38. The optical-image display system of claim 20, wherein the optical-deflection member has a deflection characteristic by which the respective portions of the individual light fluxes emitting to outside the plate have substantially uniform brightness.

39. An image-display system, comprising:
an optical-image display system according to claim 20; and
a display device comprising an image-display element situated and configured to produce the light flux.

40. An optical-image display system, comprising:
an image-introduction unit comprising an image-display element that produces an image-carrying light flux, the light flux comprising multiple respective flux components produced at each of multiple angular fields of view;
a first plate comprising walls defining an interior space, the first plate being situated relative to the image-introduction unit so as to receive the light flux from the image-display element and being configured to direct the received light flux, propagating in the interior space, along a forward trajectory path in which the light flux is internally reflected multiple times from the walls; and
an optical-deflection member disposed in a predetermined region relative to a wall of the plate and configured to reflect at least a first portion of the flux components, reaching the predetermined region, in a direction so as to cause the first portion of the flux components to pass from the optical-deflection member to an exit pupil located outside the first plate and to form a virtual image of image-carrying light flux, the virtual image being viewable by an eye of an observer positioned at the exit pupil.

41. The system of claim 40, wherein the image-display element comprises a display screen that produces the image-carrying light flux, the light flux comprising the multiple respective flux components produced at each of multiple angular fields of view of the display screen.

42. The system of claim 40, further comprising a lens situated between the image-introduction unit and the first plate.

43. The system of claim 42, wherein the lens is a collimating lens that collimates the light flux, from the image-introduction unit, entering the first plate.

44. The system of claim 42, wherein the first plate further comprises a first reflecting surface situated downstream of the lens and configured to reflect the light flux entering the first plate so as to direct the entering light flux along the forward-trajectory path in the interior space.

45. The system of claim 44, further comprising a return-reflective surface situated and configured to reflect at least a portion of the light flux, propagating in the interior space along the forward-trajectory path and after having internally reflected multiple times from the walls of the first plate, along a return-trajectory path in the interior space, thereby reciprocating the light flux in the interior space.

46. The system of claim 40, further comprising a second plate, coupled to the first plate and configured with a surface having a curvature sufficient to provide a diopter correction for the eye.

47. The system of claim 46, wherein the optical-deflection member further comprises a multi-mirror situated between the first and second plates, the multi-mirror being configured to reflect light of the light flux, propagating through the first plate, toward the optical-deflection member.

48. The system of claim 47, wherein the multi-mirror comprises a first reflective-transmissive surface and a second reflective-transmissive surface.

49. The system of claim 48, wherein:
the first reflective-transmissive surface extends substantially parallel to the first plate; and
the second reflective-transmissive surface comprises multiple elements that are inclined relative to the first reflective-transmissive member.

50. The system of claim 40, further comprising a frame to which at least the first plate is mounted.

51. The system of claim 50, wherein:
the frame is configured as an eyeglass frame configured to be worn by the observer in a manner by which the first plate is situated forwardly of the eye and the eye is positioned at the exit pupil; and
the first plate is mounted in a rim of the eyeglass frame so as to allow the observer to view the virtual image while wearing the frame.

52. The system of claim 40, wherein the optical-deflection member is configured as a reflective-transmissive member exhibiting high reflectivity to light incident thereto at a large angle of incidence and exhibits high transmissivity to light incident thereto at a small angle of incidence.

53. A method for viewing an image produced by a display that produces an image-carrying light flux, the method comprising:
directing the light flux, made up of respective individual light fluxes produced at multiple angular fields of view of the display, to enter a forward-trajectory path;
propagating the light flux in the forward-trajectory path while internally reflecting the light flux multiple times;
as the light flux is internally reflecting, deflecting at least respective first portions of the individual light fluxes within a predetermined region and in a predetermined direction to cause the respective first portions to exit the forward-trajectory path to an exit pupil; and
placing an observer's eye relative to the exit pupil to view the image carried by the exiting portions of the light fluxes.

54. The method of claim 53, further comprising reflecting the light flux, propagating forwardly along the trajectory path in the light-transmissive plate, rearwardly in a manner that returns the trajectory path in the interior space with continued internal reflection of the light flux and thus reciprocates propagation of the light flux in the interior space.

55. The method of claim 54, further comprising deflecting, in the predetermined direction, respective second portions of the individual light fluxes propagating rearwardly in the interior space so as to cause the deflected second portions to exit to the exit pupil with the deflected first portions.

56. The method of claim 53, further comprising collimating the light flux as the light flux is directed to enter the forward-trajectory path.

57. The method of claim 53, further comprising:
placing the display adjacent a head of an observer whose eye is placed relative to the exit pupil; and
situating the forward-trajectory path frontward of the observer's eye.

58. The method of claim 57, wherein the light flux is directed by reflection to enter the forward-trajectory path.

59. The method of claim 53, wherein the step of directing the at least respective first portions of the light fluxes to exit the forward-trajectory path comprises reflecting the respective first portions.

60. The method of claim 53, wherein the step of directing the at least respective first portions of the light fluxes to exit the forward-trajectory path comprises diffracting the respective first portions.

61. The method of claim 53, further comprising imparting a diopter correction to the observer's eye, with respect to an object being viewed by the eye, while the observer's eye is viewing the image carried by the exiting portions of the light fluxes.

62. The method of claim 53, wherein the step of deflecting the individual light fluxes comprises deflecting a preselected wavelength range of the light fluxes from the display.

63. The method of claim 53, wherein the step of deflecting the individual light fluxes comprises deflecting a preselected polarization state of the light fluxes from the display.

64. The method of claim 53, wherein the individual light fluxes are deflected in a manner that achieves a substantially uniform brightness, across the exit pupil, of the light exiting to the exit pupil.
